(19) United States
(12) Patent Application Publication
(10) Pub. No.: US 2026/0051129 A1
(43) Pub. Date: Feb. 19, 2026

(54) SYSTEMS AND METHODS FOR ENHANCING INTERACTIVE CONTENT CREATION AND PRESENTATION FOR EXTENDED REALITY DEVICES USING SINGLE-CAMERA TECHNOLOGY

(71) Applicant: Adeia Guides Inc., San Jose, CA (US)

(72) Inventors: Evgeny Kaminsky, Hallandale Beach, FL (US); Reda Harb, Tampa, FL (US); Tao Chen, Palo Alto, CA (US)

(21) Appl. No.: 18/806,136

(22) Filed: Aug. 15, 2024

(51) Int. Cl. G06T 19/00; G06V 10/75; G06V 20/64

(52) U.S. Cl. CPC G06T 19/006; G06V 10/75; G06V 20/647; G06T 2200/24

(57) ABSTRACT

Systems and methods are provided herein for creating interactive 3D content for XR devices using a single camera. This may be accomplished by receiving a first piece of content comprising a plurality of segments, wherein the first piece of content is recorded by a first camera. A system may identify a first object within a first segment of the first piece of content and compare the first object with a plurality of 3D models stored in a database. In response to determining that a first 3D model of the plurality of 3D models corresponds to the first object, the system then generates a second piece of content, by combining the first 3D model with the first piece of content. The system also generates an index associated with the second piece of content.

### BACKGROUND

The present disclosure relates to the generation of three-dimensional (3D) content, and in particular to techniques for generating 3D content using two-dimensional (2D) content.

### SUMMARY

The advent of extended reality (XR) devices (e.g., Apple Vision Pro, Meta Quest Virtual Reality Headset, etc.) has provided new avenues for media consumption, however creating content that fully utilizes these technologies remains a challenge. Many methods for creating 3D content require complex setups involving multiple cameras or special equipment (e.g., stereo cameras and/or light detection and ranging (LiDAR) sensors). Such setups are often costly and difficult to manage. These setups are typically used to capture static scenes without dynamic interactions, thereby underutilizing the potential of XR technologies to provide immersive, interactive user experiences. Further, even after 3D content has been generated, many social media platforms (e.g., TikTok, YouTube, etc.) primarily cater to 2D content. Said social media platforms have no or limited tools to support the creation or manipulation of XR environments, resulting in the underutilization of XR technologies.

Accordingly, techniques are disclosed herein for creating interactive 3D content for XR devices using a single camera. For example, a device with a camera may capture a video of an environment (e.g., car show). The environment may include a number of objects (e.g., cars). Accordingly, the captured video depicts the objects (e.g., cars) within the environment (e.g., car show). The captured video is a 2D video and may include a plurality of segments. For example, a first segment of the video may show a user next to a first car (e.g., Tesla) and the user may be describing the first car. A second segment of the video may show the user next to a second car (e.g., BMW) and the user may be describing the second car. The device may transmit the captured video to a video conversion service to convert one or more portions of the 2D video to 3D. The video conversion service may comprise one or more servers. In some embodiments, the device transmits the captured video to the video conversion service in real time (e.g., as the device's camera is capturing the video).

The video conversion service may analyze the 2D video to identify one or more objects. For example, the video conversion service may use an object recognition algorithm to identify a first object (e.g., Tesla) in the first segment of the video and a second object (e.g., BMW) in the second segment of the video. In another example, the video conversion service may use audio detection to determine that the audio of the first segment of the video references the first object (e.g., Tesla) and that the audio of the second segment of the video references the second object (e.g., BMW). The video conversion service may then compare the identified object(s) with a plurality of 3D models. For example, the video conversion service may have access to one or more databases that have a plurality of entries. Each entry of the plurality of entries may associate one or more 3D models with object information. For example, a first entry may associate a 3D model of the first object (e.g., a 3D model of the Tesla) with a first piece of object information (e.g., the identifier “Tesla”).

If the video conversion service determines that at least one 3D model of the plurality of 3D models corresponds to an object within the 2D video, then the video conversion service generates a first piece of 3D content by combining the identified 3D model with the received 2D video. For example, the video conversion service may determine that a first object (e.g., Tesla) in the first segment of the video corresponds to a first 3D model (e.g., a 3D model of a Tesla). After determining that at least one 3D model corresponds to the first object, the video conversion service may generate a first piece of 3D content by combining the first 3D model (e.g., a 3D model of a Tesla) with the received video. For example, the video conversion service may generate the first piece of 3D content by replacing the first object (e.g., Tesla) with the first 3D model (e.g., a 3D model of a Tesla).

If the video conversion service determines that none of the 3D models of the plurality of 3D models correspond to the object within the 2D video, then the video conversion service may transmit a notification to the device that transmitted the 2D video. For example, the video conversion service may determine that a second object (e.g., BMW) in the second segment of the video does not correspond to any 3D models stored in the 3D model databases. After determining that none of the 3D models stored in the 3D model databases correspond to the second object (e.g., BMW), the video conversion service may transmit a notification to the device that transmitted the 2D video. In some embodiments, the notification is transmitted in real time (e.g., as the device's camera is capturing the second segment). The notification may indicate that additional information is needed to generate one or more 3D models. The notification may also include one or more instructions to facilitate capturing the additional information. For example, the one or more instructions may request one or more videos of the second object (e.g., BMW) from different angles. In another example, the one or more instructions may request that the device change the position of the device's camera from a first position to one or more other positions. The one or more other positions may facilitate the camera capturing one or more videos of the second object (e.g., BMW) from different angles. The device may then transmit the additional information to the video conversion service.

The video conversion service may use the additional information received from the device to generate a 3D model. For example, the device may transmit a plurality of videos of the second object to the video conversion service, wherein the plurality of videos is from a plurality of different angles relative to the second object. The video conversion service may use the plurality of videos and the originally received 2D video to generate a second 3D model (e.g., a 3D model of a BMW) corresponding to the second object. After generating the second 3D model, the video conversion service may generate a first piece of 3D content by combining the second 3D model (e.g., a 3D model of a BMW) with the received video. For example, the video conversion service may generate the first piece of 3D content by replacing the second object (e.g., BMW) with the second 3D model (e.g., a 3D model of a BMW).

After generating the first piece of 3D content, the video conversion service may transmit the first piece of 3D content to one or more devices for display. The first piece of 3D content may include some portions in 2D and some portions in 3D. For example, the depiction of the environment of the first piece of 3D content may be in 2D while one or more depictions of objects (e.g., Tesla) may be 3D models (e.g., a 3D model of the Tesla).

The video conversion service may also generate an index associated with the first piece of 3D content. The index may comprise a plurality of entries associating segments of the first piece of 3D content with 3D models. For example, a first entry may associate the first 3D model (e.g., the 3D model of the Tesla) with the first segment (e.g., segment depicting the user next to the 3D model of the Tesla, where the user is discussing the Tesla). A second entry may associate the second 3D model (e.g., the 3D model of the BMW) with the second segment (e.g., segment depicting the user next to the 3D model of the BMW, where the user is discussing the BMW).

In some embodiments, the index is used to enable user's navigation within the first piece of 3D content. For example, an XR device may be displaying the first segment of the first piece of 3D content depicting the 3D model of the Tesla, where the audio of the first piece of 3D content is associated with the Tesla. The XR device may receive a first input (e.g., click, gaze, voice input, etc.) corresponding to the selection of the BMW. For example, the user may notice that the BMW is depicted in the background of the first segment of the first piece of 3D content and click on the depiction of the BMW. In another example, the XR device may detect that the user's gaze is directed to the BMW depicted in the background of the first segment of the first piece of 3D content. In response to the first input, the XR device may access the index associated with the first piece of 3D content. The XR device may determine that the first input corresponds to the BMW, and that the index has an entry that associates a 3D model of the BMW with a second segment (e.g., segment depicting the 3D model of the BMW, where the audio of the first piece of 3D content is associated with the BMW). In response to identifying the entry of the index corresponding to the first input, the XR device may stop displaying the first segment (e.g., depicting the 3D model of the Tesla, where the audio of the first piece of 3D content is associated with the Tesla) of the first piece of content and start displaying the second segment (e.g., depicting the 3D model of the BMW, where the audio of the second piece of 3D content is associated with the BMW).

In some embodiments, the index is used to provide navigation to other pieces of 3D content. For example, a first entry of the index corresponding to the first piece of 3D content may associate the first 3D model (e.g., the 3D model of the Tesla) with the first segment of the first piece of 3D content. The first entry may also associate the first 3D model (e.g., the 3D model of the Tesla) with additional pieces of 3D content that comprise the 3D model. For example, a second piece of 3D content may be a car manufacturer discussing one or more cars.

A third segment of the second piece of 3D content may be the car manufacturer discussing a Tesla. The first entry may associate the first 3D model (e.g., the 3D model of the Tesla) with both the first segment of the first piece of 3D content and the third segment of the second piece of 3D content because both pieces of content correspond to the first 3D model (e.g., the 3D model of the Tesla).

One or more devices may use the first entry to display an option to navigate from the first piece of 3D content to the second piece of 3D content based on both pieces of content relating to the same or similar 3D model. For example, an XR device may be displaying the first segment of the first piece of 3D content depicting the 3D model of the Tesla. In response to the first entry associating the first 3D model (e.g., the 3D model of the Tesla) with a third segment of the second piece of 3D content (e.g., car manufacturer discussing a Tesla), the XR device may overlay an option over the display of the first segment of the first piece of 3D content. If the user selects the option, the XR device may stop displaying the first segment of the first piece of 3D content and start displaying the third segment of the second piece of 3D content (e.g., car manufacturer discussing a Tesla).

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative diagram of a system for creating and/or displaying interactive 3D content for XR devices, in accordance with some embodiments of this disclosure.

FIGS. 2A-2C show illustrative diagrams of a system for identifying or generating 3D models, in accordance with some embodiments of this disclosure.

FIG. 3 shows an illustrative index in accordance with some embodiments of this disclosure.

FIG. 4 show an illustrative diagrams of a user interface displaying 3D content, in accordance with some embodiments of this disclosure.

FIGS. 5A and 5B show illustrative diagrams of a user interface displaying 3D content, in accordance with some embodiments of this disclosure.

FIG. 6 shows an illustrative block diagram of a media system, in accordance with embodiments of the disclosure.

FIG. 7 shows an illustrative block diagram of a user equipment device system, in accordance with some embodiments of the disclosure.

FIG. 8 shows an illustrative block diagram of a server system, in accordance with some embodiments of the disclosure.

FIG. 9 shows an illustrative block diagram of another user equipment device system, in accordance with some embodiments of the disclosure.

FIG. 10 is an illustrative flowchart of a process for creating interactive 3D content for XR devices, in accordance with some embodiments of this disclosure.

FIG. 11 is an illustrative flowchart of a process for displaying interactive 3D content for XR devices, in accordance with some embodiments of this disclosure.

FIG. 12 is another illustrative flowchart of a process for displaying interactive 3D content for XR devices, in accordance with some embodiments of this disclosure.

### DETAILED DESCRIPTION

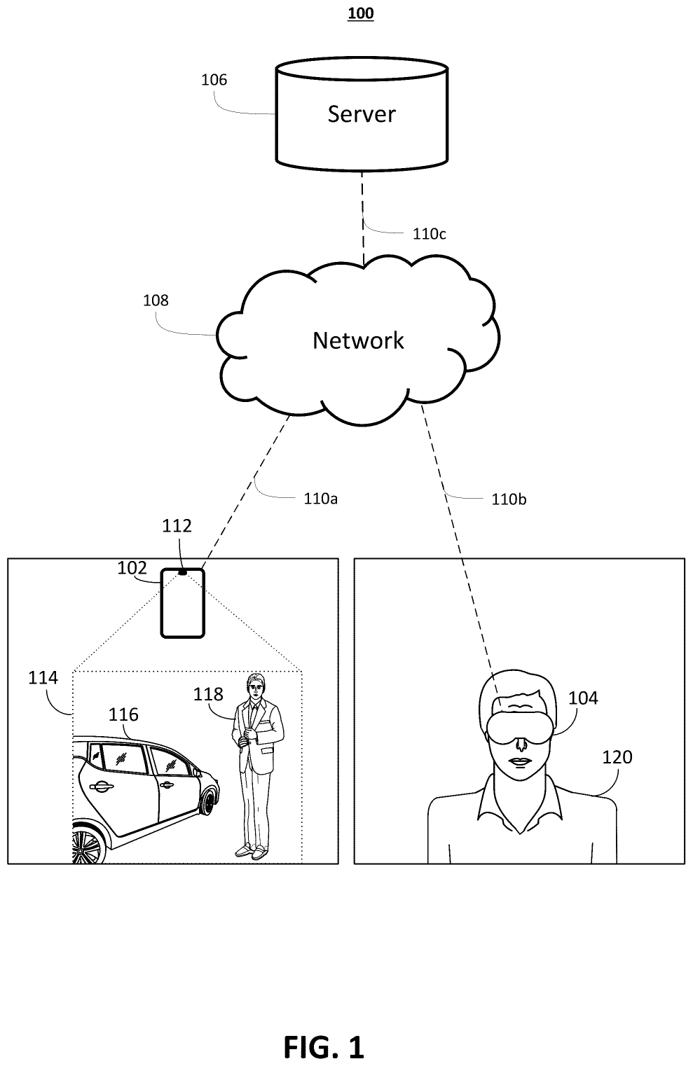

FIG. 1 shows an illustrative diagram of a system 100 for creating and/or displaying interactive 3D content for XR devices, in accordance with some embodiments of this disclosure. The system 100 includes a first user equipment device 102, a second user equipment device 104, and a server 106. In some embodiments, the first user equipment device 102 is a smartphone, a tablet, a laptop, smart glasses, a camera, and/or any other device suitable for capturing video. In some embodiments, the second user equipment device 104 is the same device as the first user equipment device 102. In some embodiments, the second user equipment device 104 is different than the first user equipment device 102. In some embodiments, the second user equipment device 104 is a smartphone, a tablet, a laptop, a desktop computer, a smart watch, a wearable device, smart glasses, a stereoscopic display, a wearable camera, XR glasses, an XR head-mounted display and/or any other device suitable for displaying interactive 3D content. In some embodiments, the server 106 is part of a video conversion service.

In the system 100, there can be more than two user equipment devices, but only two are shown in FIG. 1 to avoid overcomplicating the drawing. In addition, the system 100 may utilize more than one type of the user equipment devices and more than one of each type of the user equipment devices. Similarly, the system 100, may have more than one server 106 and network 108, but only one of each is shown in FIG. 1 to avoid overcomplicating the drawing. In some embodiments, the user equipment devices and/or server communicate with each other directly through an indirect path via the network 108. The network 108 may be one or more networks including the Internet, a mobile phone network, mobile voice or data network (e.g., a 4G, 5G, or LTE network), cable network, public switched telephone network, or other type of communications network or combinations of communications networks. In some embodiments, there may be paths 110a-c between user equipment devices and/or servers, so that the items may communicate with each other. In some embodiments, the paths 110a-c comprises one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, the paths 110a-c are wireless path. In some embodiments, communications with the devices may be provided by one or more communications paths but is shown as a single path in FIG. 1 to avoid overcomplicating the drawing.

In some embodiments, the first user equipment device 102 comprises a camera 112. The first user equipment device 102 may use the camera 112 to capture a video of an environment 114. The environment 114 may comprise a first object 116 and a second object 118. Accordingly, the captured video depicts the first object 116 and the second object 118 within the environment 114. The captured video may be a 2D video and may include a plurality of segments. For example, a first segment of the video may show a user (e.g., the second object 118) next to a first car (e.g., first object 116). The first user equipment device 102 may use the network 108 to transmit the captured video to the server 106 associated with a video conversion service. In some embodiments, the first user equipment device 102 transmits one or more portions of the captured video to the server 106 in real time (e.g., as the camera 112 is capturing one or more other portions of the video).

The first user equipment device 102 may utilize or be in conference with any suitable number of sensors to determine information related to the environment 114. For example, one or more sensors may be an image sensor, ultrasonic sensor, radar sensor, LED sensor, LiDAR sensor, or any other suitable sensor, or any combination thereof. In some embodiments, the information related to the environment includes depth data, location data, geolocation data, audio data, and/or similar such data. For example, the first user equipment device 102 may utilize one or more LiDAR sensors to capture depth data related to the first object 116 and/or the second object 118. In another example, the first user equipment device 102 may utilize one or more sensors that implement a simultaneous localization and mapping (SLAM) system to obtain location data related to the first object 116 and/or the second object 118. In another example, the first user equipment device 102 may utilize a positioning module to obtain geolocation data related to the first object 116 and/or the second object 118. In some embodiments, the first user equipment device 102 transmits the information related to the environment 114 to the server 106. In some embodiments, the first user equipment device 102 includes the information related to the environment 114 as metadata associated with the captured video.

In some embodiments, the captured video and information related to the environment 114 are processed prior to the captured video being sent to the server 106. For example, a video, image, and depth data processor (VIDDP) may process the captured video and depth data to generate a processed captured video. The process captured video and location information (e.g., generated by a SLAM system) may then be transmitted to the server 106.

The server 106 may use the captured video and/or information related to the environment to identify one or more objects depicted in the captured video. In some embodiments, the server 106 uses machine learning, computer vision, object recognition, pattern recognition, facial recognition, image processing, image segmentation, edge detection, audio detection, color pattern recognition, partial linear filtering, regression algorithms, and/or neural network pattern recognition or any other suitable technique or any combination thereof to identify one or more objects depicted in the captured video. For example, the server 106 may use an object recognition algorithm to identify the first object 116 in the first segment of the video. In another example, the server 106 may use natural language processing and the audio associated with the first segment of the captured video to determine that one or more users (e.g., second object 118) are discussing the first object 116 during the first segment of the captured video.

The server 106 may then compare the one or more identified objects and/or object information related to the one or more identified objects with a plurality of 3D models. For example, the server 106 may use an object recognition algorithm to identify the first object 116 as a Tesla in the first segment of the video. The server may then compare the identified Tesla with a plurality of 3D models to determine if one or more models of the plurality of 3D models correspond to the first object 116. In some embodiments, the server 106 has access to one or more databases that have a plurality of entries. In some embodiments, each entry of the plurality of entries associates one or more 3D models with object information. For example, a first entry may associate a 3D model of a first object (e.g., a 3D model of a Tesla) with a first piece of object information (e.g., the identifier “Tesla”).

In some embodiments, the object information comprises a plurality of features related to the one or more objects. For example, the first object 116 may be associated with a first set of features, and the second object 118 may be associated with a second set of features. The server 106 may access a database with a plurality of entries where each entry of the plurality of entries associates one or more 3D models with one or more features. The server 106 may compare the first set of features associated with the first object 116 to the plurality of entries. If the first set of features associated with the first object 116 correspond to one or more features corresponding to a 3D model (e.g., a 3D model of a Tesla), then the server 106 may identify the 3D model as corresponding to the first object 116.

In some embodiments, one or more devices may employ any suitable technique to identify one or more objects in the video. For example, the server 106 may employ image segmentation (e.g., semantic segmentation and/or instance segmentation) and classification to identify and localize different types or classes of entities in frames of the video. Such segmentation techniques may include determining which pixels belong to one or more objects. Such segmentation techniques may include determining which pixels belong to the physical environment surrounding one or more objects (e.g., the first object 116). Such segmentation techniques may include determining which pixels belong to other objects within the physical environment. In some embodiments, segmentation of a foreground and a background of the video may be performed. The server 106 may identify a shape of, and/or boundaries (e.g., edges, shapes, outline, border) at which, depiction of one or more objects (e.g., the first object 116) ends and/or analyze pixel intensity or pixel color values contained in frames of the video. The server 106 may label pixels as belonging to the depiction of one or more objects (e.g., the first object 116) or the actual physical background, to determine the location and coordinates of the one or more objects. In some embodiments, the server 106 may employ machine learning, computer vision, object recognition, pattern recognition, facial recognition, image processing, image segmentation, edge detection, or any other suitable technique or any combination thereof. Additionally, or alternatively, the server 106 may employ color pattern recognition, partial linear filtering, regression algorithms, and/or neural network pattern recognition, or any other suitable technique or any combination thereof.

If the server 106 determines that at least one 3D model of the plurality of 3D models corresponds to the first object 116 of the recorded video, then the server 106 may generate a first piece of 3D content by combining the identified 3D model with the captured video. For example, the server 106 may determine that the first object 116 in the first segment of the captured video corresponds to a first 3D model (e.g., a 3D model of a Tesla). After determining that at least one 3D model corresponds to the first object 116, the server 106 may generate a first piece of 3D content by combining the first 3D model (e.g., a 3D model of a Tesla) with the received video. For example, the video conversion service may generate the first piece of 3D content by replacing the first object 116 with the first 3D model (e.g., a 3D model of a Tesla).

In some embodiments, the server 106 transmits the first piece of 3D content to the second user equipment device 104. The first piece of 3D content may include some 2D portions and some 3D portions. For example, the depiction of the environment 114 of the first piece of 3D content may be in 2D while the first object 116 may be replaced with a 3D model (e.g., a 3D model of the Tesla). In some embodiments, the server 106 also generates an index associated with the first piece of 3D content. In some embodiments, the index associated with the first piece of 3D content is generated during the generation of the first piece of the 3D content. The index may comprise a plurality of entries associating segments of the first piece of 3D content with 3D models. For example, a first entry may associate a first 3D model (e.g., the 3D model of the Tesla) with a first segment (e.g., segment depicting the user next to the 3D model of the Tesla, where the user is discussing the Tesla). A second entry may associate a second 3D model (e.g., the 3D model of the BMW) with a second segment (e.g., segment depicting the user next to the 3D model of the BMW, where the user is discussing the BMW). In some embodiments, the server 106 transmits the index along with the first piece of 3D content to the second user equipment device 104.

In some embodiments, the index is used to provide navigation within the first piece of 3D content. For example, the second device 104 may be displaying the first segment of the first piece of 3D content depicting the 3D model of the Tesla. The second device 104 may receive a first input corresponding to the selection of the BMW. For example, a user 120 may notice that the BMW is depicted in the background of the first segment of the first piece of 3D content and change the orientation of the second device 104 (e.g., by rotating their head) to look at the depiction of the BMW. In response to the user 120 changing the orientation of the second device 104 (e.g., by rotating their head), the second device 104 may determining that the user 120 is interested in the BMW. In response to the second device 104 determining that the user 120 is interested in the BMW, the second device 104 may stop displaying the first segment (e.g., depicting the 3D model of the Tesla) of the first piece of content and start displaying the second segment (e.g., depicting the 3D model of the BMW) based on the one or more entries of the index.

In some embodiments, the index is used to provide navigation to other pieces of 3D content. For example, the second device 104 may display the first segment of the first piece of 3D content depicting the first 3D model (e.g., the 3D model of the Tesla). The second device may determine that a first entry of the index associates the first 3D model (e.g., the 3D model of the Tesla) with both the first segment of the first piece of 3D content and a second segment of a second piece of 3D content (e.g., a video of the car manufacturer discussing a Tesla). The second device 104 may display an option to view the second segment of the second piece of 3D content based, at least in part, on determining that the first entry of the index associates the first 3D model with both the first segment of the first piece of 3D content and a second segment of a second piece of 3D content. The second device 104 may overlay the option to view the second segment of the second piece of 3D content over the display of the first segment of the first piece of 3D content depicting the first 3D model. The second device 104 may then receive a first input corresponding to the selection of the second piece of content. For example, the user 120 may say “play other video.” In response to the input of the user 120, the second device 104 may stop displaying the first segment of the first piece of 3D content and start displaying the second segment of the second piece of 3D content (e.g., car manufacturer discussing a Tesla).

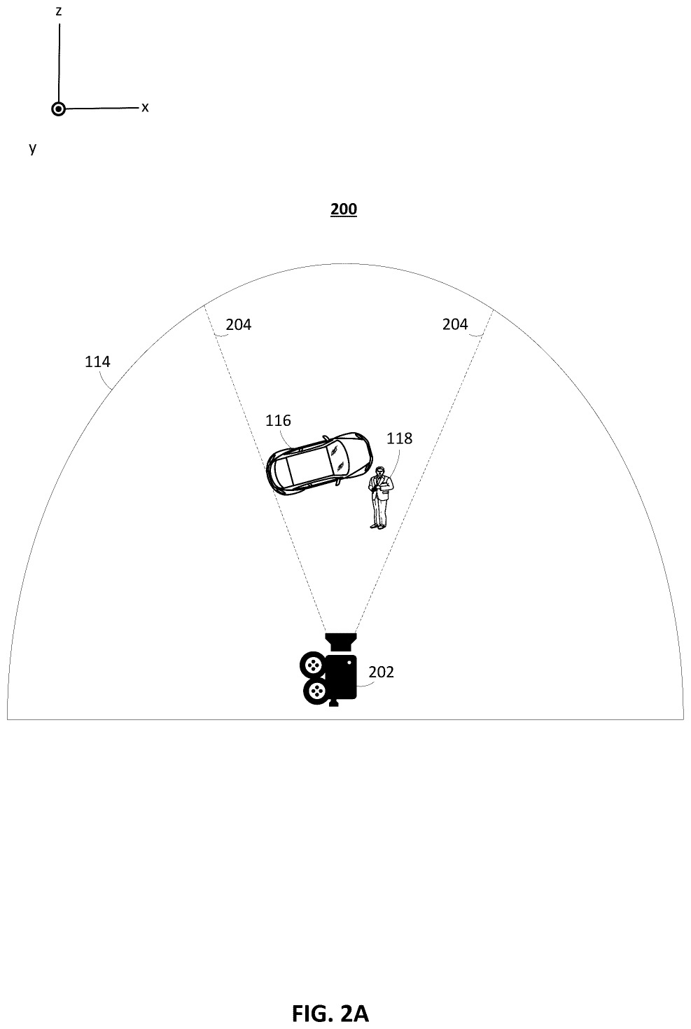

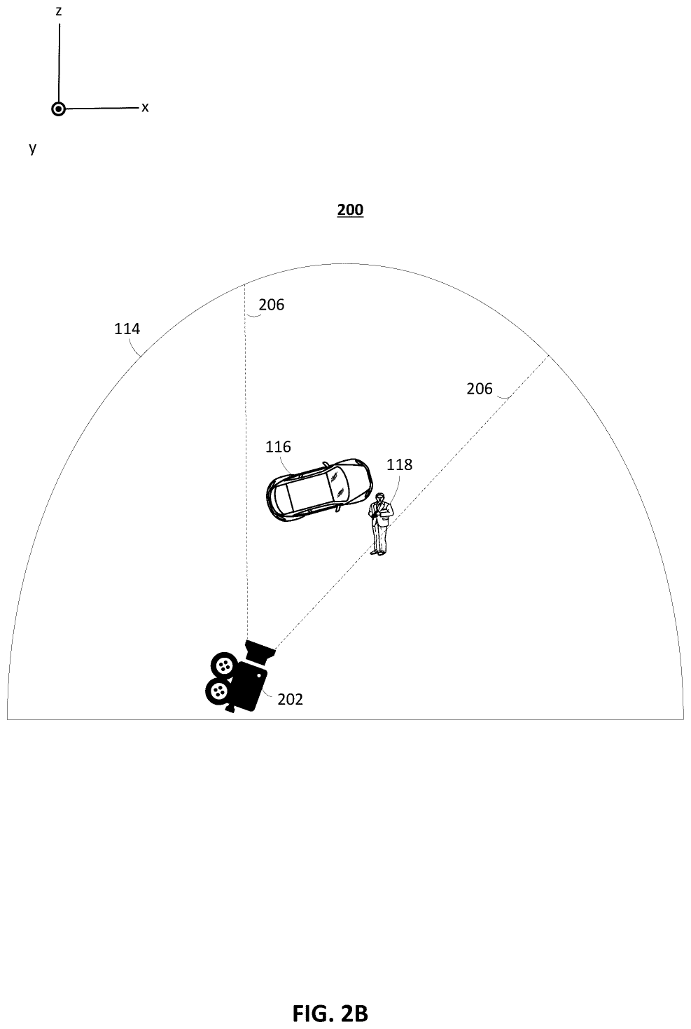

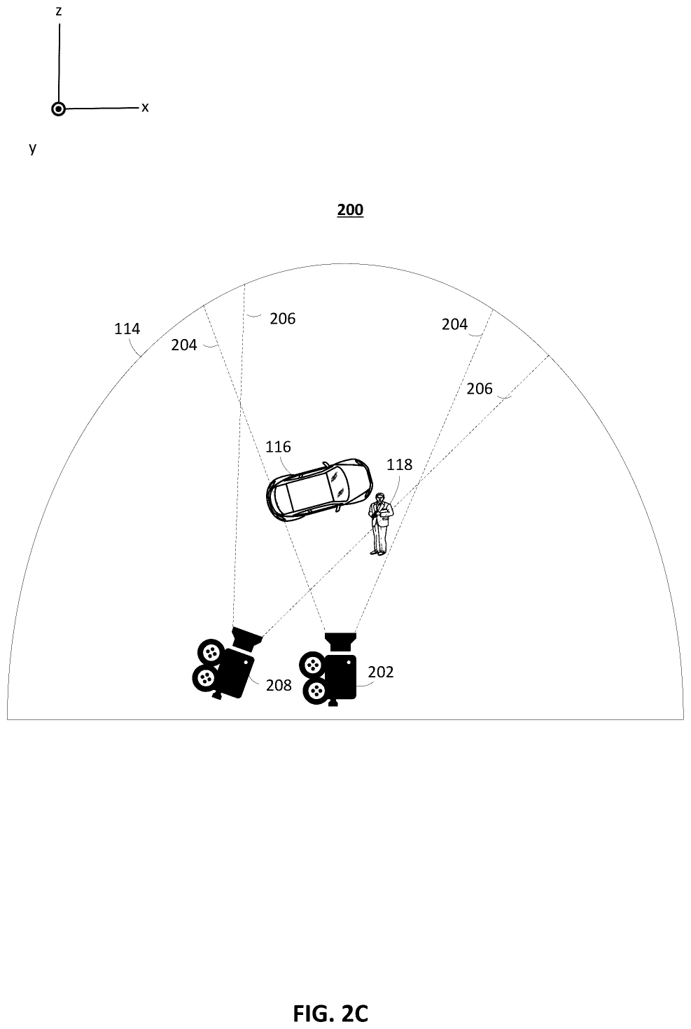

FIGS. 2A-2C show illustrative diagrams of a system 200 for identifying or generating 3D models, in accordance with some embodiments of this disclosure. The system 200 includes a first camera 202 capturing an environment 114 comprising a first object 116 and a second object 118. In some embodiments, the environment 114, first object 116, and/or second object 118 are the same or similar to the environment 114, first object 116, and/or second object 118 described in FIG. 1.

FIG. 2A shows the first camera 202 capturing a first field of view 204 of the environment 114. The information captured using the first field of view 204 may be used to generate a first video. In some embodiments, one or more user equipment devices (e.g., first user equipment device 102) may use a network (e.g., network 108) to transmit the first video to a server (e.g., server 106) associated with a video conversion service. In some embodiments, information related to the environment 114 (e.g., depth data, location data, geolocation data, audio data, and/or similar such data) is captured along with the first video as described herein and is also transmitted to the server.

The server may use the first video and/or information related to the environment 114 to identify one or more objects depicted in the first video. The server may then compare the one or more identified objects and/or object information related to the one or more identified objects with a plurality of 3D models. If the server determines that none of the 3D models of the plurality of 3D models corresponds to the objects depicted in the first video, then the server may transmit a notification. For example, the server may determine that the first object 116 of the first video does not correspond to any 3D models stored in one or more 3D model databases. After determining that none of the 3D models stored in the one or more 3D model databases correspond to the first object 116, the server may transmit a notification to one or more devices. For example, the server may transmit the notification to the first camera 202 that captured the first video. In another example, the server may transmit the notification to one or more user equipment devices (e.g., first user equipment device 102) associated with the capturing and/or transmitting of the first video. In another example, the server may transmit the notification to one or more devices (e.g., smartphone, Apple Vision Pro, robotic camera) that may assist in collecting additional information about the first object 116 and/or the environment 114. In another example, the server may transmit the notification to a second camera 208.

In some embodiments, the notification is transmitted as the first camera 202 is capturing the environment 114. For example, the first camera 202 may capture a first segment of the video. A first user equipment device may transmit the first segment of the video to the server while the first camera 202 captures a second segment of the video. If the server determines that none of the 3D models of the plurality of 3D models corresponds to one of or more objects (e.g., the first object 116) depicted in the first segment of the first video, then the server may transmit a notification to the first user equipment device that transmitted the first segment. In another example, the first camera 202 may capture a first portion of a first segment of the video. A first user equipment device may transmit the first portion of the first segment of the video to the server while the first camera 202 captures a second portion of the first segment of the video. If the server determines that none of the 3D models of the plurality of 3D models corresponds to one of or more objects (e.g., the first object 116) depicted in the first portion of the first segment of the first video, then the server may transmit a notification to the first user equipment device that transmitted the first segment.

In some embodiments, the notification is transmitted after the first camera 202 captures the environment 114. For example, the first camera 202 may capture a video comprising a plurality of segments. A first user equipment device may transmit the video to the server after the first camera 202 finishes capturing the video. If the server determines that none of the 3D models of the plurality of 3D models corresponds to one of or more objects (e.g., the first object 116) depicted in the first segment of the first video, then the server may transmit a notification to the first user equipment device that transmitted the first segment.

In some embodiments, the notification indicates that additional information is needed to generate one or more 3D models. For example, additional information may correspond to one or more videos and/or images captured at different angles. In another example, additional information may correspond to one or more videos and/or images captured with different camera settings (e.g., aperture, shutter speed, light sensitivity, shooting mode, focus, and/or similar such settings). In another example, additional information may correspond to additional depth data, location data, geolocation data, audio data, and/or similar such data.

The notification may also include one or more instructions to facilitate obtaining the additional information. For example, the server may determine that the first object 116 of the first video does not correspond to any 3D models stored in one or more 3D model databases. After determining that none of the 3D models stored in the one or more 3D model databases correspond to the first object 116, the server may transmit a notification to the first user equipment device requesting an additional video of the first object 116 from different angles. The notification may comprise a first instruction requesting the first camera 202 to capture the additional video from a second position. In response to the first instruction, the first camera 202 may move from a first position (e.g., as shown in FIG. 2A) to a second position (e.g., as shown in FIG. 2B). The first camera 202 may then capture an additional video from the second position. The first camera 202 may have a second field of view 206 of the environment 114 when capturing the additional video. The first camera 202 and/or the first user equipment device may then send the additional video to the server.

The notification may comprise instructions of varying specificity. For example, the notification may include a first instruction for a robotic camera system. The first instruction may be in a format that the robotic camera system can process. The first instruction may cause the robotic camera system to change a camera from a first camera setting to a second camera setting. In another example, the notification may include a first instruction for a video from an additional field of view. One or more devices may determine a plurality of additional fields of view that are available with the system 200. For example, a system with four robotic cameras that each have the ability to change the position and/or angle of the respective cameras has more available fields of view compared to a system with two cameras with limited mobility. Accordingly, one or more devices of system 200 may determine that a second field of view 206 is available because the first camera 202 can change positions. In response to determining that the second field of view 206 is available, the system 200 may move the first camera 202 from a first position (e.g., as shown in FIG. 2A) to a second position (e.g., as shown in FIG. 2B).

In some embodiments, the server uses the first segment of video and the additional information to generate a 3D model. For example, the server may receive the first video captured by the first camera 202 using the first field of view 204 and the second video captured by the first camera 202 using the second field of view 206. The server may use the first video and second video to generate a first 3D model (e.g., a 3D model of a Tesla) corresponding to the first object 116. After generating the first 3D model, the server may generate a first piece of 3D content by combining the first 3D model with the first video. For example, the server may generate the first piece of 3D content by replacing the first object 116 with the first 3D model (e.g., a 3D model of a tesla) in the first video. Although a first and second video are described, the server may use any number of videos to generate one or more 3D models.

In some embodiments, the server stores generated 3D models in one or more databases. In some embodiments, the stored 3D models are used for generating additional segments of the first piece of 3D content and/or for generating additional pieces of 3D content. For example, the server may receive the first video captured by the first camera 202 using the first field of view 204 and the second video captured by the first camera 202 using the second field of view 206. The server may use the first video and second video to generate a first 3D model (e.g., a 3D model of a Tesla) corresponding to the first object 116. The server may then store the first 3D model in one or more databases. The server may then receive a request to generate a second piece of 3D content using a third video. The server may identify an object in the third video that is the same or similar to the first object 116. Based, at least in part, on identifying the object in the third video that is the same or similar to the first object 116, the server may identify the first 3D model corresponding to the first object 116 in the one or more databases. The server may then generate a second piece of 3D content by combining the first 3D model with the third video.

Although FIGS. 2A and 2B show a single camera (e.g., first camera 202) capturing videos from the first field of view 204 and the second field of view 206, FIG. 2C shows an embodiment where a second camera 208 is used to capture a video from the second field of view 206. In some embodiments, the first camera 202 captures the video and the second camera 208 captures additional information used to generate 3D models. For example, the first camera 202 may capture a first segment of the first video from the first field of view 204. The server may receive the segment of the first video and determine that additional information is required to generate one or more 3D models for one or more objects (e.g., first object 116). The server may then send the notification to the second camera 208 to capture additional information about the one or more objects (e.g., first object 116) and/or about the environment 114 to facilitate the generation of one or more 3D models, while the first camera 202 continues to capture the first segment of the first video and/or additional segments of the first video. Accordingly, the first camera is able to continuously capture a video while the second camera 208 provides additional information used to translate one or more portions of the video into a piece of 3D content. The notifications and/or instructions described herein may result in the first camera 202 and/or second camera 208 capturing additional information and/or changing one or more parameters (field of view angles, positions, camera settings, etc.).

In some embodiments, the second camera 208 may generate the 3D model. For example, the second camera 208 may be connected to one or more servers (e.g., server 106) that provide video conversion services. In another example, the second camera 208 may have access to equipment capable of generating of one or more 3D models. In some embodiments, the second camera 208 also generates session information. For example, the second camera 208 may generate one or more timestamps related to a first 3D model. The timestamp may be in relation to 2D video captured by the first camera 202. The one or more timestamps may be used to combine the first 3D model with the correct segment and/or segments of the 2D video.

In some embodiments, the notification and/or instructions are transmitted in response to a quality determination. For example, the first camera 202 may capture a video comprising a plurality of segments. A first user equipment device may transmit a portion of a first segment of the video to the server after the first camera 202 finishes capturing the first segment of the video and/or while the first camera 202 is capturing the first segment of the video. The server may process the portion of a first segment to determine if the quality of the portion of a first segment is greater than a first threshold. In some embodiments, if the server determines that quality of the portion of the first segment is below the first threshold, then the server may transmit a notification. In some embodiments, the notification is transmitted to the first camera 202, one or more additional cameras (e.g., second camera 208), one or more user equipment devices, and/or similar such devices. In some embodiments, additional information is collected in response to the notification received from the server.

In another example, the first camera 202 may capture a video comprising a plurality of segments. A first user equipment device may transmit a portion of a first segment of the video to the server after the first camera 202 finishes capturing the first segment of the video and/or while the first camera 202 is capturing the first segment of the video. The server may identify a first object (e.g., first object 116) in the first segment of the video. The server may access a database and identify a first 3D model associated with the first object. The server may then determine if the quality of the first 3D model is above a first threshold. In some embodiments, if the server determines that the quality of the 3D model is below the first threshold, then the server may transmit a notification. In some embodiments, a new 3D model (corresponding to the first object) is generated based on the notification. Additional information may be collected in response to the notification received from the server and the additional information may be used to generate the new 3D model. In some embodiments, a user may select one or more quality parameters. The server may select one or more thresholds (e.g., video quality threshold, 3D model quality threshold, etc.) based on the one or more quality parameters selected by the user.

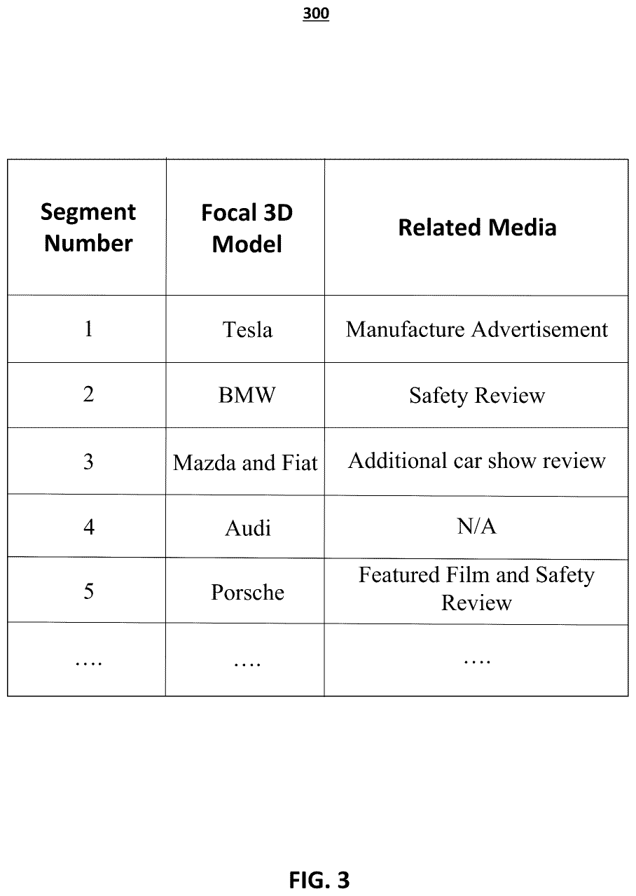

FIG. 3 shows an illustrative index 300 in accordance with some embodiments of this disclosure. In some embodiments, the index 300 is associated with a first piece of 3D content generated by one or more servers (e.g., server 106). Index 300 is just one example of a table used to store information related to a piece of 3D content, similar such tables may be used. For example, different column and row values may be used as would be clear to a person of ordinary skill in the art.

The index 300 may comprise a plurality of entries associated with the segments of the first piece of 3D content. In some embodiments, the first column of the index 300 identifies a segment of the first piece of 3D content. For example, the first row corresponds to a first segment (e.g., segment number one) of the first piece of 3D content and the second row corresponds to a second segment (e.g., segment number two) of the first piece of 3D content.

In some embodiments, the second column of the index 300 corresponds to the focal 3D model associated with the segment of the first piece of 3D content. For example, a first segment (e.g., segment number one) of the first piece of 3D may have a first 3D model (e.g., a 3D model of a Tesla) as the focal point and a second segment (e.g., segment number two) of the first piece of 3D content may have a second 3D model (e.g., a 3D model of a BMW) as the focal point.

In some embodiments, one or more devices determine the focal 3D model of a segment of the first piece of 3D content using captured video associated with the first piece of 3D content and/or information related to the environment of the first piece of 3D content. The one or more devices may also use machine learning, computer vision, object recognition, pattern recognition, facial recognition, image processing, image segmentation, edge detection, audio detection, color pattern recognition, partial linear filtering, regression algorithms, and/or neural network pattern recognition or any other suitable technique or any combination thereof to determine the focal 3D model of a segment of the first piece of 3D content. For example, a server may use an object recognition algorithm to determine that a first 3D model (e.g., 3D model of a Tesla) is the focal 3D model of the first segment of the first piece of 3D content. In another example, a server may use natural language processing and the audio associated with the second segment of the first piece of 3D content to determine that one or more users are discussing a second 3D model (e.g., 3D model of a BMW) during the second segment of the first piece of 3D content. In some embodiments, more than one 3D model is the focal point of a segment. For example, a third segment (e.g., segment number three) of the first piece of 3D may have a third 3D model (e.g., a 3D model of a Mazda) and a fourth 3D model (e.g., a 3D model of a Fiat) as the focal point.

In some embodiments, the third column of the index 300 corresponds to a piece of related media. For example, a second piece of 3D content may be a Tesla manufacturing advertisement. The second piece of 3D content may have a focal 3D model that is the same or similar to the focal 3D model of the first segment of the first piece of 3D content. Accordingly, the index 300 may associate the first 3D model (e.g., the 3D model of the Tesla) with both the first segment of the first piece of 3D content and the second piece of 3D content because both pieces of content correspond to the same or similar focal 3D model (e.g., the 3D model of the Tesla). In some embodiments, there may not be a piece of related media corresponding to a focal point of a segment. For example, a fourth segment (e.g., segment number four) of the first piece of 3D may not correspond to any pieces of related media. In some embodiments, more than one piece of related media corresponds to the focal point of a segment. For example, a fifth segment (e.g., segment number five) of the first piece of 3D may correspond to a third piece of 3D content (e.g., portion of a movie featuring a Porsche) and a fourth piece of 3D content (e.g., safety review of the Porsche).

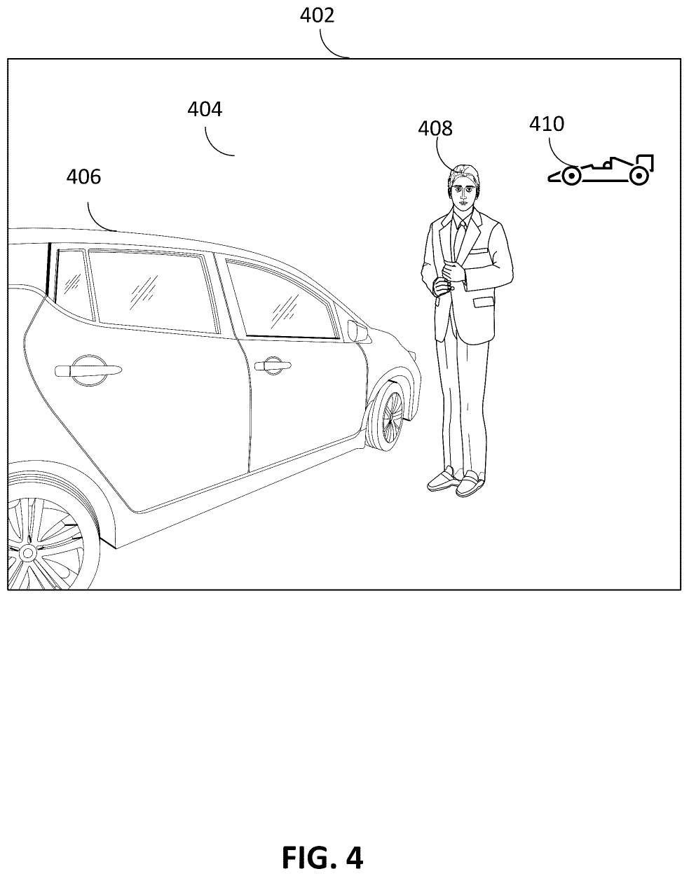

FIG. 4 shows an illustrative diagram of a user interface 402 displaying 3D content, in accordance with some embodiments of this disclosure. In some embodiments, the user interface is a display of one or more devices (e.g., the second user equipment device 104). The one or more devices may be a smartphone, a tablet, a laptop, a desktop computer, a smart watch, a wearable device, smart glasses, a stereoscopic display, a wearable camera, XR glasses, an XR head-mounted display and/or any other device suitable for displaying interactive 3D content.

In some embodiments, the user interface 402 displays a first piece of 3D content. The first piece of 3D content may include some 2D portions and some 3D portions. For example, a depiction of the environment 404 of the first piece of 3D content may be in 2D while a first object (e.g., first object 116) may be a first 3D model 406 (e.g., a 3D model of the first object). In some embodiments, the first piece of 3D content also comprises a second object 408 and a third object 410. In some embodiments, the user interface 402 displays the second object 408 and/or the third object 410 in 2D. In some embodiments, the user interface 402 displays the second object 408 and/or the third object 410 in 3D.

In some embodiments, one or more users may interact with the first piece of 3D content. For example, a user may use one or more gestures (e.g., turning their head, pinching their fingers, moving their eyes, etc.) to view the first 3D model from different viewpoints. In another example, a user may scroll, zoom, click, etc., in order to view the second object 408 in varying level of detail (e.g., zoomed in). In some embodiments, one or more interactions are supported by an index (e.g., index 300) associated with the first piece of 3D content. For example, while an XR device is displaying the first segment of the first piece of 3D content on the user interface 402, the XR device may receive a first input (e.g., click, gaze, etc.) corresponding to the selection of the third object 410. In response to the first input, the XR device may access the index associated with the first piece of 3D content. The XR device may determine that the first input corresponds to the third object 410, and that the index has an entry that associates a focal 3D model of the third object 410 with a second segment of the first piece of 3D content. In response to identifying the entry of the index corresponding to the first input, the XR device may stop displaying the first segment with a first focal 3D model (e.g., the first 3D model 406) and start displaying the second segment with a second focal 3D model corresponding to the third object 410).

In some embodiments, the index comprises a plurality of links associated with a 2D video and/or the first piece of 3D content. For example, the index may link the first 3D model 406 of the first piece of 3D content to a first object (e.g., first object 116) in a 2D video. In some embodiments, one or more portions of the user interface 402 correspond to one or more of the plurality of links. For example, the user interface 402 may display a first segment of the first piece of 3D content. The first segment of the first piece of 3D content may comprise the first 3D model 406. The index associated with the first piece of 3D content may comprise a first link indicating that the first 3D model 406 is the focal 3D model of the first segment of the first piece of 3D content. In another example, the first segment of the first piece of 3D content may comprise the third object 410. The index associated with the first piece of 3D content may comprise a first link indicating that the first segment of the first piece of 3D content comprises the third object 410. In another example, a second segment of a 2D video may comprise the third object 410. The index associated with the first piece of 3D content may comprise a first link indicating that the second segment of the 2D video comprises the third object 410.

The plurality of links may be used to modify the 2D video and/or the first piece of 3D content. For example, a user may select an option to remove the first 3D model 406 from the first piece of 3D content. One or more devices (e.g., server 106, second user equipment device 104, etc.) may use the plurality of links to determine which segments of the first piece of 3D content comprise the first 3D model 406. The one or more devices may then remove the identified segments that comprise the first 3D model 406. In another example, a user may select an option to remove the first 3D model 406. One or more devices (e.g., server 106, second user equipment device 104, etc.) may use the plurality of links to determine which segments of the 2D video comprise an object (e.g., first object 116) corresponding to the first 3D model 406. The one or more devices may then remove the identified segments that comprise the object (e.g., first object 116) corresponding to the first 3D model 406.

In some embodiments, one or more devices modify the 2D video and/or the first piece of 3D content by replacing one or more 3D models and/or objects. For example, a user may select an option to replace the first 3D model 406 from the first piece of 3D content with a second 3D model. One or more devices (e.g., server 106, second user equipment device 104, etc.) may use the plurality of links to determine which segments of the first piece of 3D content comprise the first 3D model 406. The one or more devices may then replace the first 3D model 406 in the identified segments with the second 3D model. In another example, a user may select an option to replace the first 3D model 406. One or more devices (e.g., server 106, second user equipment device 104, etc.) may use the plurality of links to determine which segments of the 2D video comprise an object (e.g., first object 116) corresponding to the first 3D model 406. The one or more devices may then replace the object (e.g., first object 116) corresponding to the first 3D model 406 in the identified segments with a second object. In some embodiments, the one or more devices uses one or more computer vision algorithm to replace the first 3D model 406 with a second 3D model and/or replace an object (e.g., first object 116) corresponding to the first 3D model 406 with a second object.

In some embodiments, modifying the 2D video and/or the first piece of 3D content comprises updating one or more manifest files. For example, a user may select an option to remove the first 3D model 406 from the first piece of 3D content. One or more devices may modify a manifest associated with the first piece of 3D content by removing one or more portions of the manifest associated with the first 3D model 406. In another example, a user may select an option to remove the first 3D model 406 from the first piece of 3D content. One or more devices may modify a manifest associated with the first piece of 3D content by marking one or more portions of the manifest associated with the first 3D model 406 as non-playable. In some embodiments, the one or more devices identify portions of the manifest associated with a selected 3D model using one or more identifiers. For example, a user may select an option to remove the first 3D model 406 from the first piece of 3D content. The manifest associated with the first piece of 3D may have a plurality of portions. Each portion that relates to the first 3D model 406 may comprise a first identifier related to the first 3D model 406. One or more devices may mark one or more portions of the manifest that comprise the first identifier as non-playable. In some embodiments, removing a portion of the manifest and/or marking a portion of the manifest as non-playable results in the portion of the manifest being deleted. In some embodiments, removing a portion of the manifest and/or marking a portion of the manifest as non-playable results in the portion of the manifest being deactivated. In some embodiments, one or more portions of the manifest may be reactivated in response to a user input.

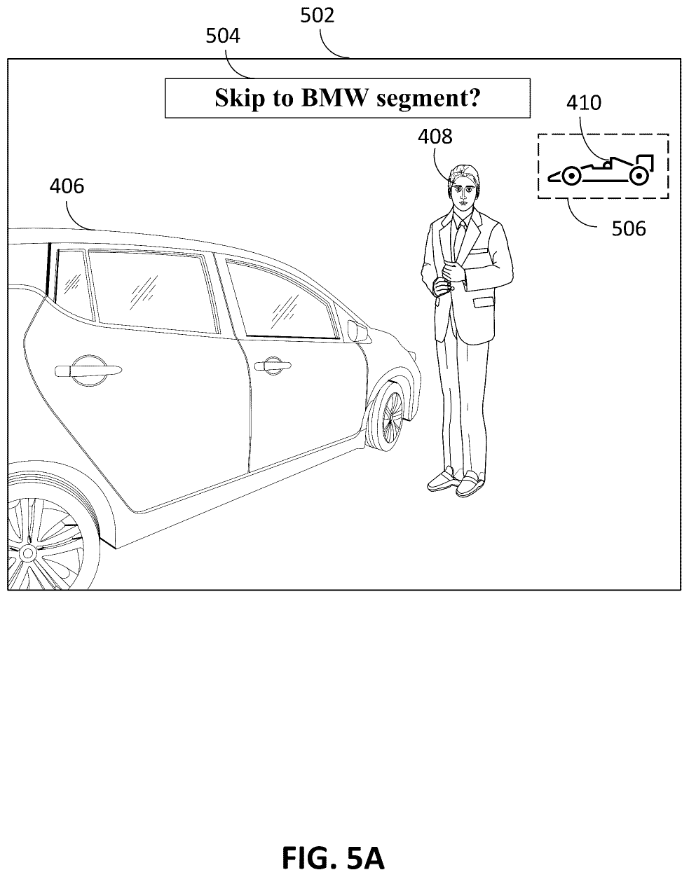

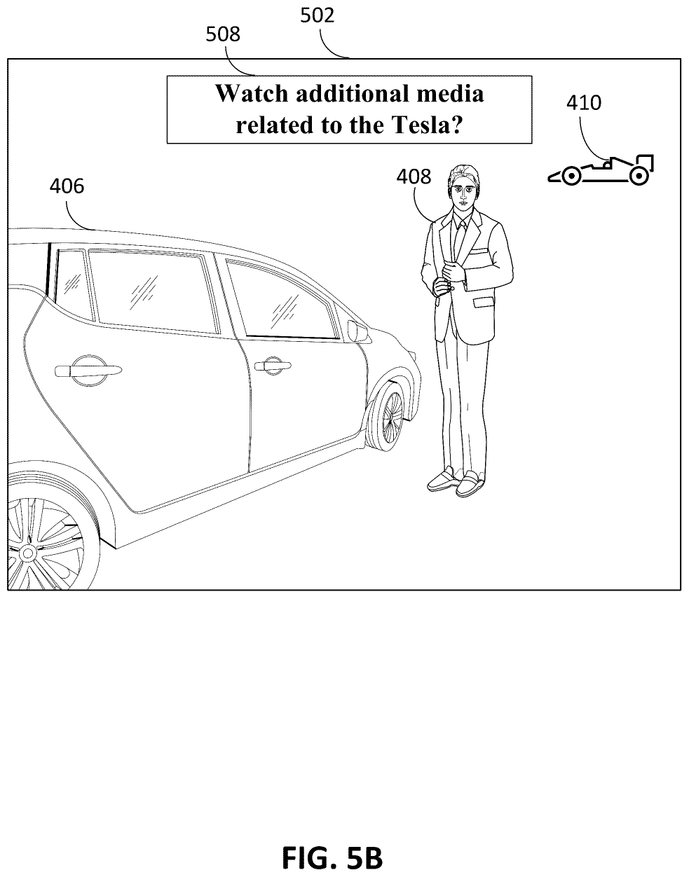

FIGS. 5A and 5B show illustrative diagrams of a user interface 502 displaying 3D content, in accordance with some embodiments of this disclosure. In some embodiments, the user interface 502 is a display of one or more devices (e.g., the second user equipment device 104). The one or more devices may be a smartphone, a tablet, a laptop, a desktop computer, a smart watch, a wearable device, smart glasses, a stereoscopic display, a wearable camera, XR glasses, an XR head-mounted display and/or any other device suitable for displaying interactive 3D content. In some embodiments, the user interface 502 is the same or similar to the user interface (e.g., user interface 402) described in FIG. 4.

In FIG. 5A, the user interface 502 displays a first segment of the first piece of 3D content. In some embodiments, an XR device may receive a first input (e.g., click, gaze, user input, etc.) corresponding to the selection of the third object 410 while the XR device is displaying the first segment of the first piece of 3D content on the user interface 502. In some embodiments, the user interface 502 displays an indicator 506 in response to the first input. In some embodiments, the XR device also accesses an index associated with the first piece of 3D content. The XR device may determine that the first input corresponds to the third object 410, and that the index has an entry that associates a focal 3D model of the third object 410 with a second segment of the first piece of 3D content. In response to identifying the entry of the index corresponding to the first input, the user interface 502 may display a first option 504.

In some embodiments, the first option 504 allows a user to navigate to a different segment of the first piece of 3D content. For example, if a user selects the first option 504 then the user interface 502 may stop displaying the first segment (e.g., depicting the first 3D model 406) of the first piece of 3D content and start displaying the second segment (e.g., depicting the 3D model of the third object 410). Although skipping is described the first option 504 may provide navigation to any part of the first piece of 3D content. For example, the first option 504 may allow for fast-forwarding, rewinding, skipping forward, skipping backward, and/or similar such navigation operations.

In FIG. 5B, the user interface 502 displays a first segment of the first piece of 3D content. In some embodiments, as the user interface 502 displays a first segment of the first piece of 3D content one or more devices (e.g., XR device, server, etc.) may access the index associated with the first piece of 3D content. In some embodiments, the one or more devices determine that a first index entry associates the first 3D model 406 with both the first segment of the first piece of 3D content and a second segment of a second piece of 3D content (e.g., a video of the car manufacturer discussing a Tesla). In some embodiments, in response to determining that the first index entry associates the first 3D model 406 with both the first segment of the first piece of 3D content and the second segment of a second piece of 3D content, the user interface 502 displays a second option 508.

In some embodiments, the second option 508 allows a user to navigate to a different piece of 3D content. For example, if a user selects the second option 508 then the user interface 502 may stop displaying the first segment of the first piece of 3D content and start displaying the second segment of the second piece of 3D content (e.g., a video of the car manufacturer discussing a Tesla). In another example, if a user selects the second option 508 then the user interface 502 may display the first segment of the first piece of 3D content on a first portion of user interface 502 and display the second segment of the second piece of 3D content on a second portion of the user interface 502. In some embodiments, the user can interact with one or more pieces of 3D content at the same time. For example, the user may zoom in on the first segment of the first piece of 3D content displayed on a first portion of user interface 502 and may change angles of a second segment of the second piece of 3D content on a second portion of the user interface 502.

In some embodiments, the user interface 502 displays other pieces of content. For example, a user may be interacting with a first piece of content (e.g., a depiction of a first store). The first piece of content may comprise a first 3D model (e.g., a 3D model of a first pair of shoes available at the first store). In response to one or more inputs, the user interface 502 may display a second 3D model (e.g., a 3D model of a second pair of shoes available at a second store) related to the first 3D model at the same time the user interface 502 is displaying the first 3D model. In some embodiments, one or more indexes comprise entries linking the first 3D model with the second 3D model. For example, a first entry may link the first 3D model (e.g., a 3D model of the first pair of shoes available at the first store) with the second 3D model (e.g., a 3D model of the second pair of shoes available at the second store) because the two 3D models are the same type (e.g., shoes). The user interface 502 displaying both 3D models may allow a user to compare the first 3D model with the second 3D model. In another example, a first entry may link the first 3D model (e.g., a 3D model of the first pair of shoes available at the first store) with the second 3D model (e.g., a 3D model of a shirt available at the second store) because the two 3D models are the same type (e.g., clothing). The user interface 502 displaying both 3D models may allow a user to create an outfit using products from different stores, without having to navigate (either virtually or physically) between the two stores.

One or more devices may generate transitional content to be displayed between segments of pieces of content. For example, an XR device may receive a first input (e.g., click, gaze, etc.) corresponding to the selection of the third object 410 as the user interface 502 is displaying a first segment of the first piece of content. The index associated with the first piece of content may have an entry that associates a focal 3D model of the third object 410 with a second segment of the first piece of 3D content. The user interface 502 may stop displaying the first segment and start displaying the second segment based, at least in part on the entry. A server (e.g., server 106) and/or a user equipment device (e.g., second user equipment device 104) may generate a first piece of transitional content to be displayed between the time of the displaying of the first segment and the displaying of the second segment.

In some embodiments, the transitional content facilitates transitioning between the segments of the pieces of content. For example, the first piece of content may be of a user (e.g., second object 408) reviewing different cars at a car show. A first segment of the first piece of content may be the user reviewing a first car (e.g., Tesla) corresponding to the first 3D model 406. A second segment of the first piece of content may be the user reviewing a second car (e.g., BMW) corresponding to the third object 410. When a user switches between the first segment and the second segment, the user interface 502 may display the transitional content. The transitional content may include audio, video, and/or images. For example, the transitional content may have audio saying “Now let's see what BMW has in store for us, particularly the BMW i7.” In another example, the transitional content may comprise one or more graphics (e.g., BMW logo). After display of the transitional content the user interface 502 may display the second segment. In some embodiments, the transitional content creates a narrative continuity that enhances the viewer's sense of interaction and presence.

In some embodiments, one or more pieces of artificial intelligence (AI) technology is used to generate one or more pieces of supplemental content. An AI system may receive and process a plurality of pieces of supplemental content from a plurality of different sources and generate one or more pieces of supplemental content. For example, the AI system may process a plurality of videos from a first source (e.g., first content creator). The AI system may then generate a first piece of supplemental content that mimics one or more characteristics of the plurality of videos from the first source. In some embodiments, the AI system is updated based on one or more inputs related to a piece of supplemental content. For example, a user may reshoot a first piece of supplemental content that is generated by the AI system to generate an updated piece of supplemental content. The AI system may compare the first piece of supplemental content with the updated piece of supplemental content to identify one or more changes. The AI system may use the one or more changes to improve subsequent generation of supplemental content.

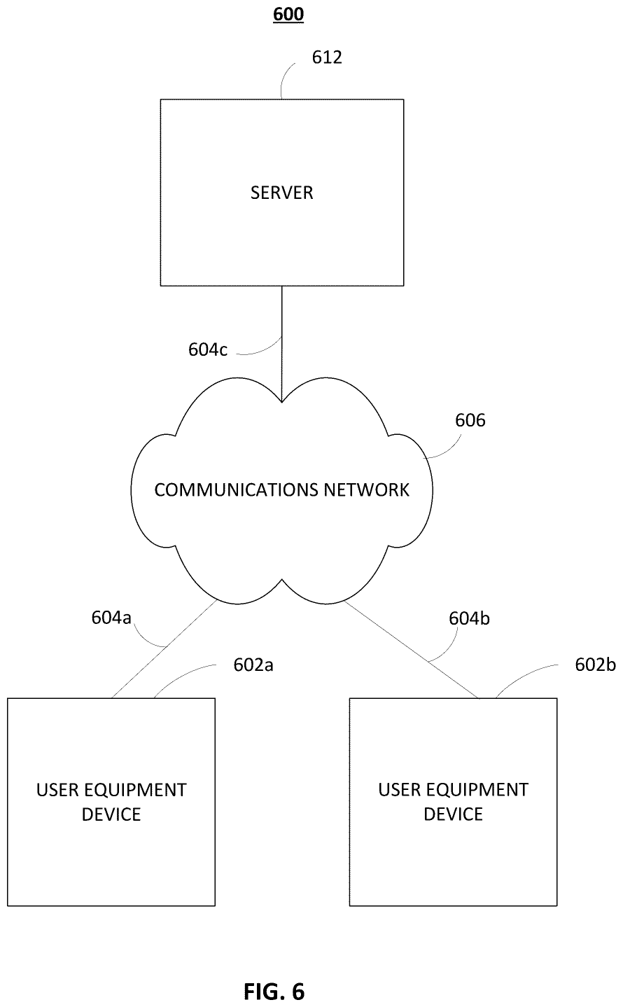

FIGS. 6-9 describe exemplary devices, systems, servers, and related hardware for creating interactive 3D content for XR devices. In the system 600, there can be more than or less than two user equipment devices 602 but only a first user equipment device 602a and a second user equipment device 602b are shown in FIG. 6 to avoid overcomplicating the drawing. In addition, users may utilize more than one type of user equipment device 602 and more than one of each type of user equipment device.

The first user equipment device 602a, the second user equipment device 602b, and a server 612, may be coupled to communications network 606. Namely, the first user equipment device 602a is coupled to the communications network 606 via a first communications path 604a, the second user equipment device 602b is coupled to the communications network 606 via a second communications path 604b, and the server 612 is coupled to the communications network 606 via a third communications path 604c. The communications network 606 may be one or more networks including the Internet, a mobile phone network, mobile voice or data network (e.g., a 4G, 5G, or LTE network), cable network, public switched telephone network, or other types of communications network or combinations of communications networks. The paths 604 may separately or in together with other paths include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In one embodiment, the paths 604 can be a wireless path. Communication with the user equipment devices 602 may be provided by one or more communications paths but is shown as a single path in FIG. 6 to avoid overcomplicating the drawing.

The server 612 can be coupled to any number of databases. For example, the server 612 may have access to a 3D model database, a content database, an index database, a 2D mapping database, a 3D mapping database, a user information database, and/or similar such databases. The server 612 may store and execute various software modules for creating interactive 3D content for XR devices. In the system 600, there can be more than one server 612 but only one is shown in FIG. 6 to avoid overcomplicating the drawing. In addition, the system 600 may utilize more than one type of server 611 and more than one of each type of server.

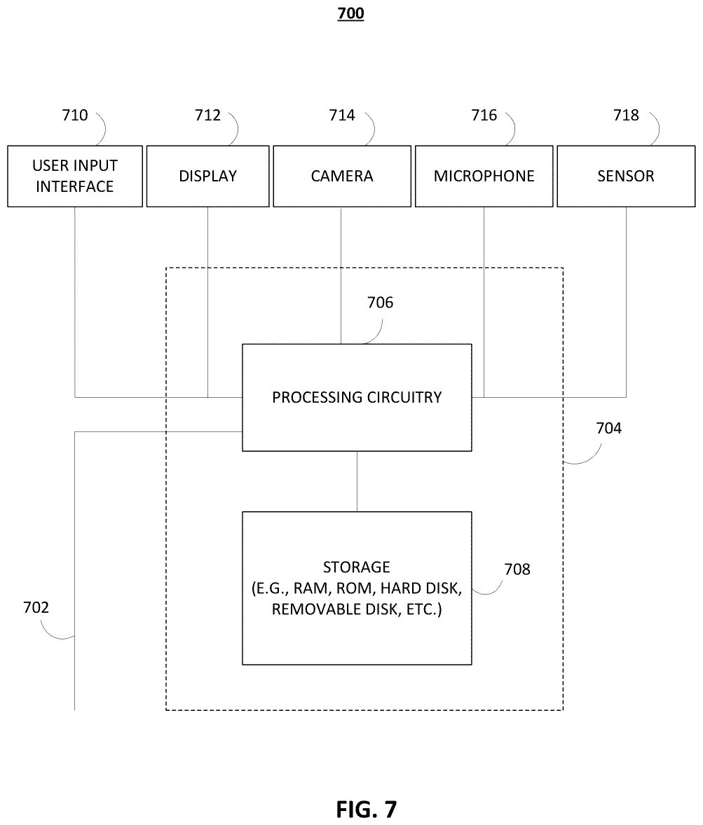

FIG. 7 shows a generalized embodiment of a user equipment device 700, in accordance with one embodiment. In an embodiment, the user equipment device 700 is an example of the first user equipment device described in FIG. 1 (e.g., device 102), the user equipment device described in FIGS. 2A and 2B (e.g., device 202), and the first user equipment device described in FIG. 6 (e.g., first user equipment device 602a). The user equipment device 700 may receive and/or transmit content and data via input/output (I/O) path 702. The I/O path 702 may provide audio content (e.g., broadcast programming, on-demand programming, Internet content, content available over a local area network (LAN) or wide area network (WAN), and/or other content) and data to control circuitry 704, which includes processing circuitry 706 and a storage 708. The control circuitry 704 may be used to send and receive commands, requests, and other suitable data using the I/O path 702. The I/O path 702 may connect the control circuitry 704 (and specifically the processing circuitry 706) to one or more communications paths. I/O functions may be provided by one or more of these communications paths but are shown as a single path in FIG. 7 to avoid overcomplicating the drawing.

The control circuitry 704 may be based on any suitable processing circuitry such as the processing circuitry 706. As referred to herein, processing circuitry should be understood to mean circuitry based on one or more microprocessors, microcontrollers, digital signal processors, programmable logic devices, field-programmable gate arrays (“FPGAs”), application-specific integrated circuits (“ASICs”), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The creating of interactive 3D content for XR devices functionality can be at least partially implemented using the control circuitry 704. The creating of interactive 3D content for XR devices functionality described herein may be implemented in or supported by any suitable software, hardware, or combination thereof.

In client-server-based embodiments, the control circuitry 704 may include communications circuitry suitable for communicating with one or more servers that may at least implement the described creating of interactive 3D content for XR devices functionality. The instructions for carrying out the above-mentioned functionality may be stored on the one or more servers. Communications circuitry may include a cable modem, an integrated service digital network (“ISDN”) modem, a digital subscriber line (“DSL”) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 708 that is part of the control circuitry 704. As referred to herein, the phrase “electronic storage device” or “storage device” should be understood to mean any device for storing electronic data, computer software, or firmware, such as random-access memory, read-only memory, hard drives, optical drives, digital video disc (“DVD”) recorders, compact disc (“CD”) recorders, BLU-RAY disc (“BD”) recorders, BLU-RAY 3D disc recorders, digital video recorders (“DVR”, sometimes called a personal video recorder, or “PVR”), solid-state devices, quantum storage devices, gaming consoles, gaming media, or any other suitable fixed or removable storage devices, and/or any combination of the same. The storage 708 may be used to store various types of content described herein. Nonvolatile memory may also be used (e.g., to launch a boot-up routine and other instructions). In some embodiments, cloud-based storage may be used to supplement the storage 708 or instead of the storage 708.

The control circuitry 704 may include audio generating circuitry and tuning circuitry, such as one or more analog tuners, audio generation circuitry, filters or any other suitable tuning or audio circuits or combinations of such circuits. The control circuitry 704 may also include scaler circuitry for upconverting and down converting content into the preferred output format of the user equipment device 700. The control circuitry 704 may also include digital-to-analog converter circuitry and analog-to-digital converter circuitry for converting between digital and analog signals. The tuning and encoding circuitry may be used by the user equipment device 700 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 708 is provided as a separate device from the user equipment device 700, the tuning and encoding circuitry (including multiple tuners) may be associated with the storage 708.

The user may utter instructions to the control circuitry 704, which are received by the microphone 716. The microphone 716 may be any microphone (or microphones) capable of detecting human speech. The microphone 716 is connected to the processing circuitry 706 to transmit detected voice commands and other speech thereto for processing. In some embodiments, voice assistants (e.g., Siri, Alexa, Google Home and similar such voice assistants) receive and process the voice commands and other speech.

The user equipment device 700 may optionally include an interface 710. The interface 710 may be any suitable user interface, such as a remote control, mouse, trackball, keypad, keyboard, touch screen, touchpad, stylus input, joystick, or other user input interfaces. A display 712 may be provided as a stand-alone device or integrated with other elements of the user equipment device 700. For example, the display 712 may be a touchscreen or touch-sensitive display. In such circumstances, the interface 710 may be integrated with or combined with the microphone 716. When the interface 710 is configured with a screen, such a screen may be one or more of a monitor, a television, a liquid crystal display (“LCD”) for a mobile device, active matrix display, cathode ray tube display, light-emitting diode display, organic light-emitting diode display, quantum dot display, or any other suitable equipment for displaying visual images. In some embodiments, the interface 710 may be HDTV-capable. In some embodiments, the display 712 may be a 3D display. In some embodiments, the user equipment device 700 also comprises one or more speakers. The one or more speakers may be controlled by the control circuitry 704. The one or more speakers may be provided as integrated with other elements of user equipment device 700 or may be a stand-alone unit. In some embodiments, the display 712 may be output through the one or more speakers.

In an embodiment, the display 712 is a headset display (e.g., when the user equipment device 700 is an XR headset). The display 712 may be an optical see-through (OST) display, wherein the display includes a transparent plane through which objects in a user's physical environment can be viewed by way of light passing through the display 712. The user equipment device 700 may generate for display virtual or augmented objects to be displayed on the display 712, thereby augmenting the real-world scene visible through the display 712. In an embodiment, the display 712 is a video see-through (VST) display.

In some embodiments, the user equipment device 700 comprises a camera 714. Although only one camera 714 is shown, any number of cameras may be used. In some embodiments, the user equipment device 700 may optionally include a sensor 718. Although only one sensor 718 is shown, any number of sensors may be used. In some embodiments, the sensor 718 is a depth sensor, Lidar sensor, and/or any similar such sensor.

In some embodiments, the user equipment device 700 utilizes a video conversion application. In some embodiments, the video conversion application may be a client/server application where only the client application resides on the user equipment device 700, and a server application resides on an external server (e.g., server system 800). For example, the video conversion application may be implemented partially as a client application on control circuitry 704 of the user equipment device 700 and partially on server system 800 as a server application running on server control circuitry 810. Server system 800 may be a part of a local area network with the user equipment device 700 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server system 800 and/or an edge computing device), referred to as “the cloud.” The user equipment device 700 may be a cloud client that relies on the cloud computing capabilities from server system 800 to determine whether processing (e.g., at least a portion of virtual background processing and/or at least a portion of other processing tasks) should be offloaded from the mobile device, and facilitate such offloading. When executed by control circuitry of server system 800, the video conversion application may instruct control circuitry 704 to perform processing tasks for the client device and facilitate the video conversion. The client application may instruct control circuitry 704 to determine whether processing should be offloaded.

Control circuitry 704 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 704 may also include scaler circuitry for upconverting and downconverting content into the preferred output format. Multiple tuners may be provided to handle simultaneous tuning functions (e.g., watch and record functions, picture-in-picture (PIP) functions, multiple-tuner recording, etc.). If storage 708 is provided as a separate device from the user equipment device 700, the tuning and encoding circuitry (including multiple tuners) may be associated with storage 708.

The video conversion application may be implemented using any suitable architecture. For example, it may be a stand-alone application wholly-implemented on the user equipment device 700. In such an approach, instructions of the application may be stored locally (e.g., in storage 708), and data for use by the application is downloaded on a periodic basis (e.g., from an out-of-band feed, from an Internet resource, or using another suitable approach). Control circuitry 704 may retrieve instructions of the application from storage 708 and process the instructions to provide video conversion functionality and generate any of the displays discussed herein. Based on the processed instructions, control circuitry 704 may determine what action to perform when input is received from the interface 710. For example, movement of a cursor on a display up/down may be indicated by the processed instructions when the interface 710 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, the video conversion application may be downloaded and interpreted or otherwise run by an interpreter or virtual machine (run by control circuitry 704). In some embodiments, the video conversion application may be encoded in the ETV Binary Interchange Format (EBIF), received by control circuitry 704 as part of a suitable feed, and interpreted by a user agent running on control circuitry 704. For example, the video conversion application may be an EBIF application. In some embodiments, the video conversion may be defined by a series of JAVA-based files that are received and run by a local virtual machine or other suitable middleware executed by control circuitry 704. In some of such embodiments (e.g., those employing MPEG-2, MPEG-4, HEVC or any other suitable digital media encoding schemes), video conversion application may be, for example, encoded and transmitted in an MPEG-2 object carousel with the MPEG audio and video packets of a program.

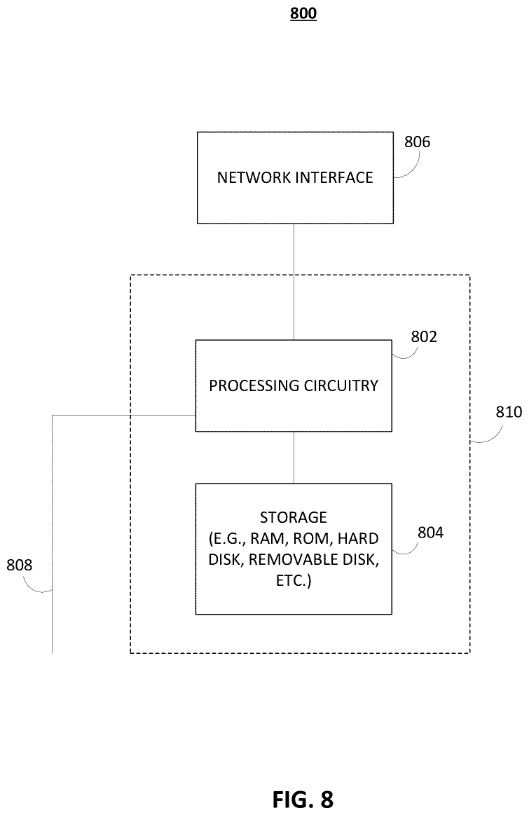

FIG. 8 shows an illustrative block diagram of a server system 800, in accordance with some embodiments of the disclosure. Server system 800 may include one or more computer systems (e.g., computing devices), such as a desktop computer, a laptop computer, and a tablet computer. In some embodiments, the server system 800 is a data server that hosts one or more databases (e.g., databases of 3D models), or modules or may provide various executable applications or modules. In practice, and as recognized by those of ordinary skill in the art, items shown separately could be combined and some items could be separated. In some embodiments, not all shown items must be included in server system 800. In some embodiments, server system 800 may comprise additional items.

The server system 800 can include processing circuitry 802 that includes one or more processing units (processors or cores), storage 804, one or more network or other communications network interfaces 806, and one or more I/O paths 808. I/O paths 808 may use communication buses for interconnecting the described components. I/O paths 808 can include circuitry (sometimes called a chipset) that interconnects and controls communications between system components. Server system 800 may receive content and data via I/O paths 808. The I/O path 808 may provide data to control circuitry 810, which includes processing circuitry 802 and a storage 804. The control circuitry 810 may be used to send and receive commands, requests, and other suitable data using the I/O path 808. The I/O path 808 may connect the control circuitry 810 (and specifically the processing circuitry 802) to one or more communications paths. I/O functions may be provided by one or more of these communications paths but are shown as a single path in FIG. 8 to avoid overcomplicating the drawing.

The control circuitry 810 may be based on any suitable processing circuitry such as the processing circuitry 802. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 804 that is part of the control circuitry 810. Storage 804 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 804 or the computer-readable storage medium of the storage 804 stores an operating system, which includes procedures for handling various basic system services and for performing hardware dependent tasks. In some embodiments, storage 804 or the computer-readable storage medium of the storage 804 stores a communications module, which is used for connecting the server system 800 to other computers and devices via the one or more communication network interfaces 806 (wired or wireless), such as the internet, other wide area networks, local area networks, metropolitan area networks, and so on. In some embodiments, storage 804 or the computer-readable storage medium of the storage 804 stores a web browser (or other application capable of displaying web pages), which enables a user to communicate over a network with remote computers or devices. In some embodiments, storage 804 or the computer-readable storage medium of the storage 804 stores a database for 3D model data, content item data, index data, 2D mapping data, 3D mapping data, user information, and/or similar such information.

In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 804 stores a subset of the modules and data structures identified above. In some embodiments, the storage 804 may store additional modules or data structures not described above.

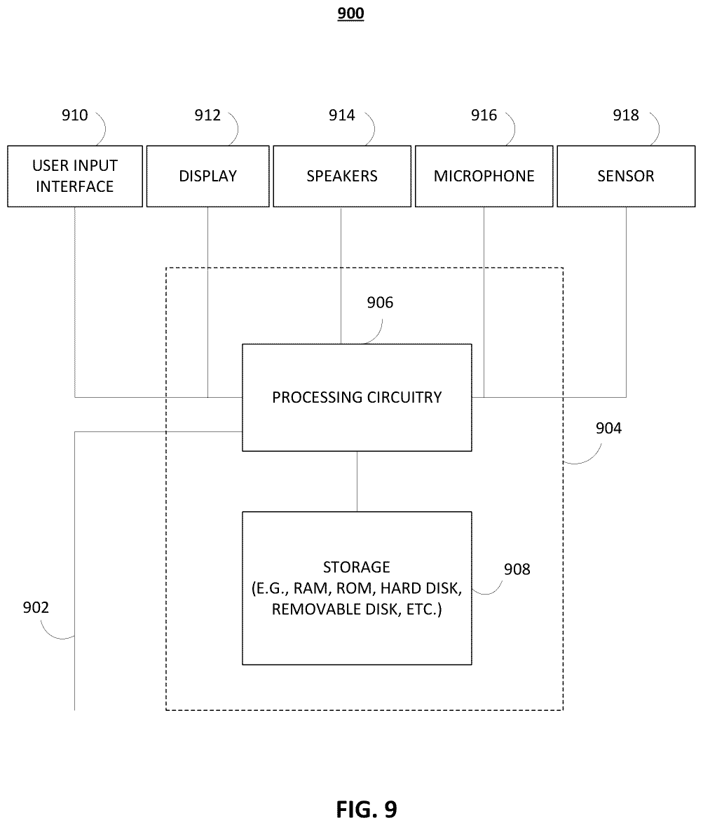

FIG. 9 shows another generalized embodiment of a user equipment device 900, in accordance with one embodiment. In an embodiment, the user equipment device 900 is an example of the second user equipment device described in FIG. 1 (e.g., device 104) and the second user equipment device described in FIG. 6 (e.g., second user equipment device 602b). The user equipment device 900 may receive and/or transmit content and data via I/O path 902. The I/O path 902 may provide audio content (e.g., broadcast programming, on-demand programming, Internet content, content available over a LAN or WAN, and/or other content) and data to control circuitry 904, which includes processing circuitry 906 and a storage 908. The control circuitry 904 may be used to send and receive commands, requests, and other suitable data using the I/O path 902. The I/O path 902 may connect the control circuitry 904 (and specifically the processing circuitry 906) to one or more communications paths. I/O functions may be provided by one or more of these communications paths but are shown as a single path in FIG. 9 to avoid overcomplicating the drawing.

The control circuitry 904 may be based on any suitable processing circuitry such as the processing circuitry 906. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The creating and/or displaying of the interactive 3D content for XR devices functionality can be at least partially implemented using the control circuitry 904. The creating and/or displaying of the interactive 3D content for XR devices functionality described herein may be implemented in or supported by any suitable software, hardware, or combination thereof.

In client-server-based embodiments, the control circuitry 904 may include communications circuitry suitable for communicating with one or more servers that may at least implement the described creating and/or displaying of interactive 3D content for XR devices functionality. The instructions for carrying out the above-mentioned functionality may be stored on the one or more servers. Communications circuitry may include a cable modem, an ISDN modem, a DSL modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 908 that is part of the control circuitry 904. For example, the electronic storage device may be any device for storing electronic data, computer software, or firmware, such as random-access memory, read-only memory, hard drives, optical drives, DVD recorders, CD recorders, BD recorders, BLU-RAY 3D disc recorders, DVRs, solid-state devices, quantum storage devices, gaming consoles, gaming media, or any other suitable fixed or removable storage devices, and/or any combination of the same. The storage 908 may be used to store various types of content described herein. Nonvolatile memory may also be used (e.g., to launch a boot-up routine and other instructions). In some embodiments, cloud-based storage may be used to supplement the storage 908 or instead of the storage 908.

The control circuitry 904 may include audio generating circuitry and tuning circuitry, such as one or more analog tuners, audio generation circuitry, filters or any other suitable tuning or audio circuits or combinations of such circuits. The control circuitry 904 may also include scaler circuitry for upconverting and down converting content into the preferred output format of the user equipment device 900. The control circuitry 904 may also include digital-to-analog converter circuitry and analog-to-digital converter circuitry for converting between digital and analog signals. The tuning and encoding circuitry may be used by the user equipment device 900 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 908 is provided as a separate device from the user equipment device 900, the tuning and encoding circuitry (including multiple tuners) may be associated with the storage 908.

The user may utter instructions to the control circuitry 904, which are received by the microphone 916. The microphone 916 may be any microphone (or microphones) capable of detecting human speech. The microphone 916 is connected to the processing circuitry 906 to transmit detected voice commands and other speech thereto for processing. In some embodiments, voice assistants (e.g., Siri, Alexa, Google Home and similar such voice assistants) receive and process the voice commands and other speech.

The user equipment device 900 may optionally include an interface 910. The interface 910 may be any suitable user interface, such as a remote control, mouse, trackball, keypad, keyboard, touch screen, touchpad, stylus input, joystick, or other user input interfaces. A display 912 may be provided as a stand-alone device or integrated with other elements of the user equipment device 900. For example, the display 912 may be a touchscreen or touch-sensitive display. In such circumstances, the interface 910 may be integrated with or combined with the microphone 916. When the interface 910 is configured with a screen, such a screen may be one or more of a monitor, a television, an LCD for a mobile device, active matrix display, cathode ray tube display, light-emitting diode display, organic light-emitting diode display, quantum dot display, or any other suitable equipment for displaying visual images. In some embodiments, the interface 910 may be HDTV-capable. In some embodiments, the display 912 may be a 3D display. In some embodiments, the speaker 914 is controlled by the control circuitry 904. The speaker (or speakers) 914 may be provided as integrated with other elements of user equipment device 900 or may be a stand-alone unit. In some embodiments, the display 912 may be output through speaker 914.

In an embodiment, the display 912 is a headset display (e.g., when the user equipment device 900 is an XR headset). The display 912 may be an optical see-through (OST) display, wherein the display includes a transparent plane through which objects in a user's physical environment can be viewed by way of light passing through the display 912. The user equipment device 900 may generate for display virtual or augmented objects to be displayed on the display 912, thereby augmenting the real-world scene visible through the display 912. In an embodiment, the display 912 is a VST display. In some embodiments, the user equipment device 900 may optionally include a sensor 918. Although only one sensor 918 is shown, any number of sensors may be used. In some embodiments, the sensor 918 is a camera, depth sensors, Lidar sensor, and/or any similar such sensor. In some embodiments, the sensor 918 (e.g., image sensor(s) or camera(s)) of the user equipment device 900 may capture the real-world environment around the user equipment device 900. The user equipment device 900 may then render the captured real-world scene on the display 912. The user equipment device 900 may generate for display virtual or augmented objects to be displayed on the display 912, thereby augmenting the real-world scene visible on the display 912.

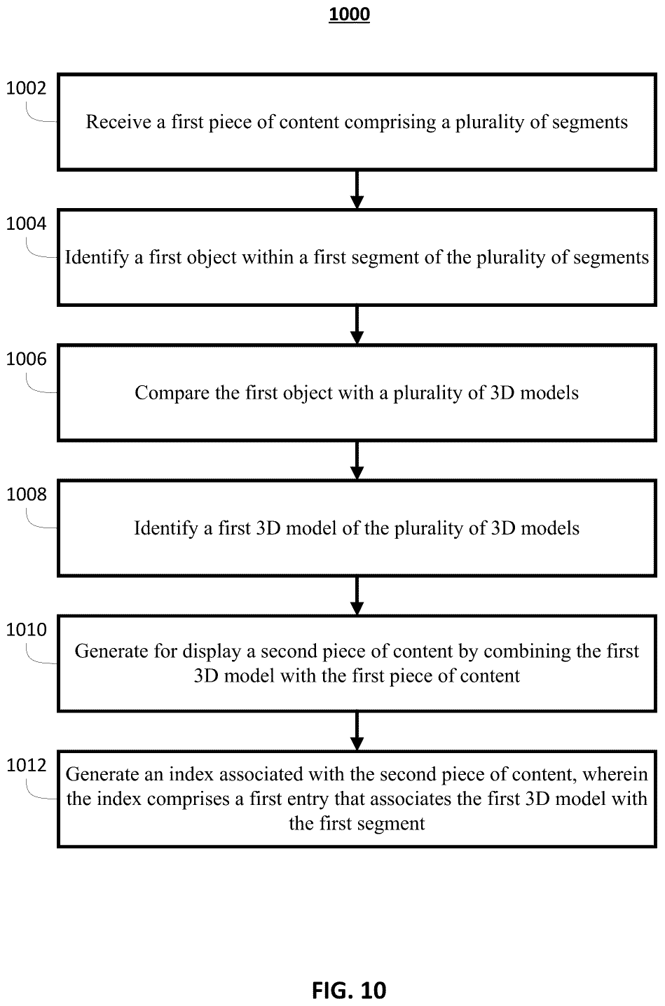

FIG. 10 is an illustrative flowchart of a process 1000 for creating interactive 3D content for XR devices, in accordance with some embodiments of the disclosure. Process 1000, and any of the following processes, may be executed by control circuitry (e.g., control circuitry 704 and control circuitry 904) on one or more user equipment devices (e.g., user equipment device 700 and user equipment device 900) and/or control circuitry 810 on a server 800. In some embodiments, control circuitry may be part of a remote server separated from one or more user equipment devices by way of a communications network or distributed over a combination of both. In some embodiments, instructions for executing process 1000 may be encoded onto a non-transitory storage medium (e.g., the storage 708, the storage 804, the storage 908) as a set of instructions to be decoded and executed by processing circuitry (e.g., the processing circuitry 706, the processing circuitry 802, the processing circuitry 906). Processing circuitry may, in turn, provide instructions to other sub-circuits contained within control circuitry, such as the encoding, decoding, encrypting, decrypting, scaling, analog/digital conversion circuitry, and the like. It should be noted that any of the processes, or any step thereof, could be performed on, or provided by, any of the devices described herein. Although the processes are illustrated and described as a sequence of steps, it is contemplated that various embodiments of the processes may be performed in any order or combination and need not include all the illustrated steps.

At 1002, control circuitry receives a first piece of content comprising a plurality of segments. In some embodiments, the first piece of content is captured using one or more cameras (e.g., camera 714). In some embodiments, the control circuitry receives the first piece of content from the one or more cameras. In some embodiments, the control circuitry receives the first piece of content from one or more user equipment devices. For example, a server (e.g., server 106) may receive the first piece of content from a first user equipment device (e.g., the first user equipment device 102). In some embodiments, the control circuitry receives the first piece of content in real time. For example, a server may receive the first piece of content from a user equipment device as the one or more cameras are capturing additional portions of the first piece of content. The first piece of content may be a video of an environment (e.g., car show). The environment may include a number of objects (e.g., cars). Accordingly, the first piece of content depicts the objects (e.g., cars) within the environment (e.g., car show). The first piece of content may be a 2D video and may include a plurality of segments. For example, a first segment of the first piece of content may show a first car (e.g., first object 116) next to a user (e.g., the second object 118).

In some embodiments, the control circuitry also receives information related to the first piece of media content. For example, one or more sensors (e.g., image sensor, ultrasonic sensor, radar sensor, LED sensor, LiDAR sensor, or any other suitable sensor, or any combination thereof) may capture depth data, location data, geolocation data, audio data, and/or similar such data related to the environment depicted in the first piece of media content. In some embodiments, the information related to the first piece of media content is included in metadata associated with the first piece of media content.

At 1004, control circuitry identifies a first object within a first segment of the plurality of segments. The control circuitry may use the first segment of the plurality of segment and/or information related to the first piece of media content to identify the first object within the first segments. For example, the control circuitry may use an object recognition algorithm to identify a first object (e.g., Tesla) in the first segment of the video and a second object (e.g., BMW) in the second segment of the video. In another example, the control circuitry may use audio detection to determine that the audio of the first segment of the video references the first object (e.g., Tesla) and that the audio of the second segment of the video references the second object (e.g., BMW).

In some embodiments, the control circuitry utilizes any suitable number or types of image processing techniques to identify the one or more objects depicted in the segments. In some embodiments, control circuitry utilizes one or more machine learning models (e.g., naive Bayes algorithm, logistic regression, recurrent neural network, convolutional neural network (CNN), bi-directional long short-term memory recurrent neural network model (LSTM-RNN), or any other suitable model, or any combination thereof) to localize, identify, and/or classify the one or more objects depicted in the segments. For example, a machine learning model may output a value, a vector, a range of values, any suitable numeric representation of classifications of objects, or any combination thereof indicative of one or more predicted classifications and/or locations and/or associated confidence values. In some embodiments, the classifications may be understood as any suitable categories into which objects may be classified, identified, and/or characterized. In some embodiments, the model may be trained on a plurality of labeled image pairs, where image data may be preprocessed and represented as feature vectors. For example, the training data may be labeled or annotated with indications of locations of multiple entities and/or indications of the type or class of each entity.

At 1006, control circuitry compares the first object with a plurality of 3D models. In some embodiments, the control circuitry has access to one or more databases that have a plurality of entries. In some embodiments, each entry of the plurality of entries associates one or more 3D models with object information. For example, a first entry may associate a 3D model of a first object (e.g., a 3D model of a Tesla) with a first piece of object information (e.g., the identifier “Tesla”). In some embodiments, the control circuitry extracts one or more features for an object (e.g., first object 116) and compares the extracted features to those stored in the one or more databases. For example, one or more dimensions, shapes, colors, or any other suitable information, or any combination thereof, corresponding to the first object may be extracted from the first piece of media. The control circuitry may compare the one or more extracted features with features stored in the one or more databases.

At 1008, control circuitry identifies a first 3D model of the plurality of 3D models. In some embodiments, the control circuitry identifies the first 3D model of the plurality of 3D models based on the comparing at step 1006.

At 1010, control circuitry generates for display a second piece of content by combining the first 3D model with the first piece of content. For example, the control circuitry may determine that the first object (e.g., first object 116) in the first segment of the captured video corresponds to a first 3D model (e.g., a 3D model of a Tesla). After determining that at least one 3D model corresponds to the first object, the control circuitry may generate the second piece of content by combining the first 3D model (e.g., a 3D model of a Tesla) with the first piece of content. For example, the control circuitry may generate the second piece of content by replacing the first object with the first 3D model (e.g., a 3D model of a Tesla).

At 1012, control circuitry generates an index associated with the second piece of content, wherein the index comprises a first entry that associates the first 3D model with the first segment. In some embodiments, the control circuitry generates the index during the generation of the second piece of content. The index may comprise a plurality of entries associating segments of the second piece of content with 3D models. In some embodiments, the index is used to provide navigation within the second piece of content and/or to additional pieces of content.

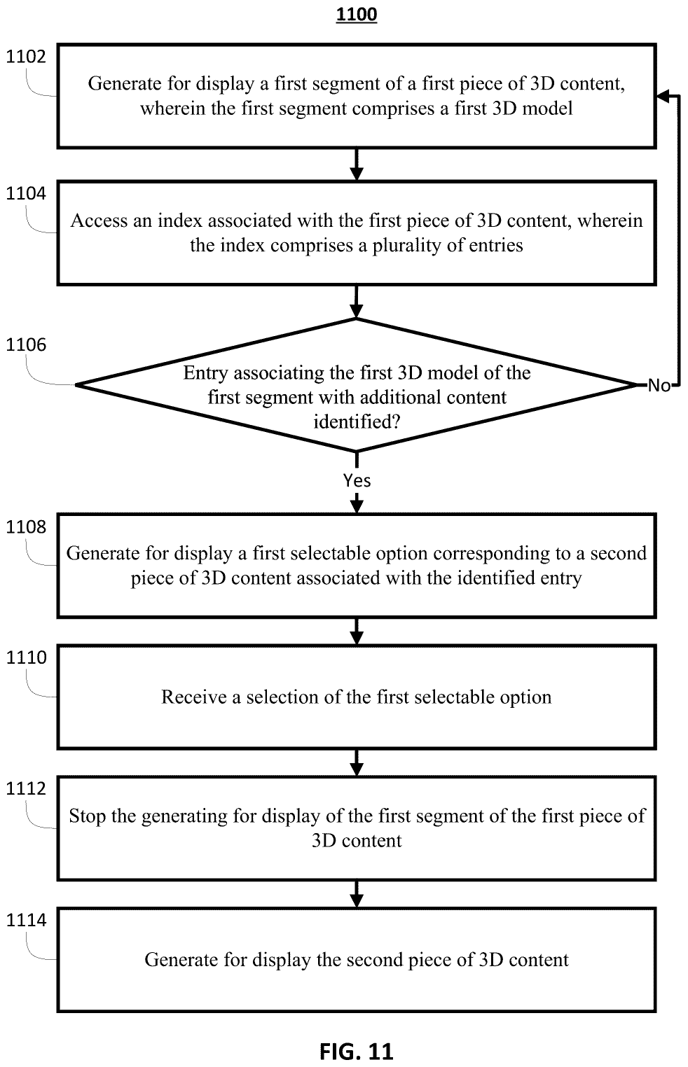

FIG. 11 is an illustrative flowchart of a process for displaying interactive 3D content for XR devices, in accordance with some embodiments of this disclosure.

At 1102, control circuitry generates for display a first segment of a first piece of 3D content. In some embodiments, the control circuitry generates for display the first segment of the first piece of 3D content then transmits the first piece of 3D content to be displayed. For example, the control circuitry may transmit the first piece of 3D content to a user interface or to a user equipment device. In some embodiments, the first segment of the first piece of content is displayed using one or more devices (e.g., smartphone, a tablet, a laptop, a desktop computer, a smart watch, a wearable device, smart glasses, a stereoscopic display, a wearable camera, XR glasses, an XR head-mounted display and/or any other device suitable for displaying interactive 3D content).

At 1104, control circuitry accesses an index associated with the first piece of 3D content, wherein the index comprises a plurality of entries. In some embodiments, the index comprises a plurality of entries associating 3D models with segments of content. For example, a first entry of the index may associate a first 3D model (e.g., a 3D model of a Tesla) with both the first segment of the first piece of 3D content (e.g., a video of car show discussing the Tesla) and a second segment of a second piece of 3D content (e.g., a video of the car manufacturer discussing the Tesla).

At 1106, control circuitry determines whether an entry associating the first 3D model of the first segment with an additional piece of content is identified. If the control circuitry determines that an entry associating the first 3D model of the first segment with an additional piece of content is identified, then the process 1100 continues to step 1108. If the control circuitry determines that an entry associating the first 3D model of the first segment with an additional piece of content is not identified, then the process 1100 returns to step 1102 where the control circuity continues to generate for display the first segment of the first piece of 3D content.

At 1108, control circuitry generates for display a first selectable option corresponding to a second piece of 3D content associated with the entry identified at step 1106. In some embodiments, the first selectable option is overlaid over the first segment of the first piece of 3D content while the first segment of the first piece of 3D content is displayed.

At 1110, control circuitry receives a selection of the first selectable option. In some embodiments, the control circuitry receives the selection in response to one or more user inputs (e.g., turning their head, pinching their fingers, moving their eyes, scrolling, zooming, clicking, and/or similar such user inputs).

At 1112, control circuitry stops the generating for display of the first segment of the first piece of 3D content. At 1114, control circuitry generates for display the second piece of 3D content. In some embodiments, the control circuitry stops the generating for display of the first segment of the first piece of 3D content and/or generates for display the second piece of 3D content in response to receiving the selection of the first selectable option at step 1110. In some embodiments, the control circuitry determines a content source of the second piece of 3D content using the index. For example, the first entry associating the first 3D model with both the first segment of the first piece of 3D content and the second piece of 3D content may comprise a first content source of the second piece of 3D content. The control circuitry may use the identified content source to generate for display the second piece of 3D content.

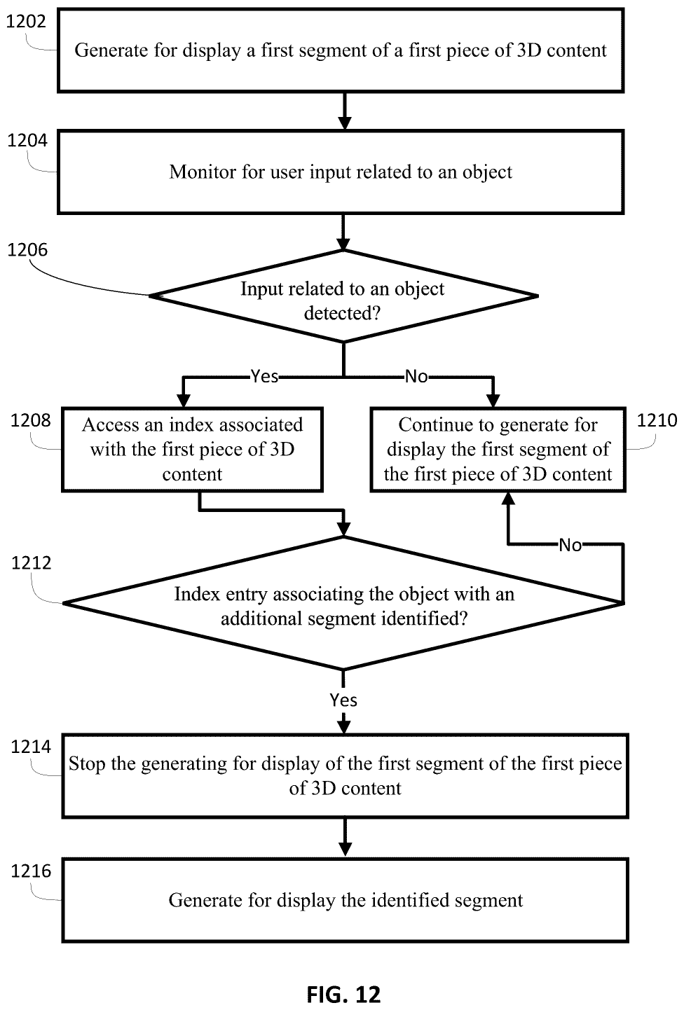

FIG. 12 is another illustrative flowchart of a process for displaying interactive 3D content for XR devices, in accordance with some embodiments of this disclosure.

At 1202, control circuitry generates for display a first segment of a first piece of 3D content. In some embodiments, the control circuitry uses the same or similar methodologies described at step 1102 to generate for display the first segment of the first piece of 3D content.

At 1204, control circuitry monitors for a user input related to an object. In some embodiments, the control circuitry uses one or more sensors to monitor for user inputs related to an object (e.g., turning their head, pinching their fingers, moving their eyes, scrolling, zooming, clicking, and/or similar such user inputs). For example, the control circuitry may monitor a user's gaze by tracking the eye movements of a user. If a user's gaze is directed to the object for more than a threshold time period (e.g., five seconds), then the control circuitry may register a first user input related to the object. In another example, the control circuitry may monitor for a click. If a user clicks on an object, then the control circuitry may register a first user input related to the object that was clicked on.

At 1206, control circuitry determines whether an input related to an object is detected. If the control circuitry determines that the input related to an object is detected, then the process 1200 continues to step 1208. If the control circuitry determines that an input related to an object is not detected, then the process 1200 continues to step 1210 where the control circuitry continues to generate for display the first segment of the first piece of 3D content.

At 1208, control circuitry accesses an index associated with the first piece of 3D content. In some embodiments, the index comprises a plurality of entries associating objects with segments of the first piece of 3D content. For example, a first entry may associate a first object (e.g., a first 3D model) with a first segment. A second entry may associate a second object (e.g., a second 3D model) with a second segment. In another example, a first entry may associate a first object (e.g., a first 3D model) with a first segment. A second entry may associate a second object (e.g., a first 2D object) with a second segment.

At 1212, control circuitry determines whether an index entry associating the object with an additional segment is identified. For example, the control circuitry may be displaying the first segment of the first piece of 3D content depicting a first object and a second object. The control circuitry may receive a first input corresponding to the selection of the second object (e.g., user gaze directed at the second object). In response to the first input, the control circuitry may access an entry in the index associated with the second object. If the entry associates the second object with a segment (e.g., second segment) other than the first segment, then the control circuitry may determine that there is an index entry associating the second object with an additional segment. If the control circuitry determines that an index entry associating the object with an additional segment is identified, then the process 1200 continues to step 1214. If the control circuitry determines that an index entry associating the object with an additional segment is not identified, then the process 1200 continues to step 1210 where the control circuitry continues to generate for display the first segment of the first piece of 3D content.

At 1214, control circuitry stops the generating for display of the first segment of the first piece of 3D content. At 1216, control circuitry generates for display the additional segment identified at step 1212. In some embodiments, the control circuitry stops the generating for display of the first segment of the first piece of 3D content and/or generates for display the additional segment in response to determining whether an index entry associating the object with an additional segment is identified. In some embodiments, the control circuitry displays a selectable option (e.g., first option 504) to navigate to the additional content and only proceeds to steps 1214 and 1216 in response to receiving a selection of the selectable option. In some embodiments, the additional segment is part of the first piece of 3D content. In some embodiments, the additional segment is part of a second piece of 3D content.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving a first piece of content comprising at least one segment, wherein the first piece of content was recorded by a first camera;
identifying, by a server, a first object within a first segment of the at least one segment;
comparing the first object with a plurality of three-dimensional (3D) models stored in a database;
in response to determining that at least one 3D model of the plurality of 3D models corresponds to the first object, identifying a first 3D model of the plurality of 3D models based, at least in part, on comparing the first object with the plurality of 3D models stored in the database;
generating for display a second piece of content, by combining the first 3D model of the plurality of 3D models with the first piece of content; and
generating an index associated with the second piece of content, wherein,
the index associated with the second piece of content comprises a plurality of entries;
a first entry of the plurality of entries, associates the first 3D model with the first segment; and
the index is stored in at least one memory.

2. The method of claim 1, further comprising:
identifying, by the server, a second object within a second segment of the at least one segment;
comparing the second object with the plurality of 3D models stored in the database; and
in response to determining that at least one 3D model of the plurality of 3D models corresponds to the second object, identifying a second 3D model of the plurality of 3D models based, at least in part, on comparing the second object with the plurality of 3D models stored in the database.

3. The method of claim 2, wherein:
the second piece of content is generated by combining the first 3D model of the plurality of 3D models and the second 3D model of the plurality of 3D models with the first piece of content; and
a second entry of the plurality of entries, associates the second 3D model with the second segment.

4. The method of claim 3, further comprising, in response to determining that none of the plurality of 3D models corresponds to the first object:
transmitting a notification to the first camera, wherein the notification requests additional information;
receiving from the first camera, additional information; and
generating, by the server, the first 3D model using the first piece of content and the additional information.

5. The method of claim 4, wherein the additional information comprises additional pieces of content depicting the first object from a plurality of different angles.

6. The method of claim 5, wherein the notification comprises a first instruction.

7. The method of claim 6, further comprising changing the first camera from a first position to a second position according to the first instruction, wherein the additional information is captured using the first camera at the second position.

8. The method of claim 1, wherein the server identifies the first object within the first piece of content using an object recognition algorithm.

9. The method of claim 1, further comprising:
generating for display a first selectable option, wherein:
the first selectable option corresponds to a second segment of a third piece of content; and
the first entry also associates the first 3D model with the second segment of the third piece of content;
receiving a selection of the first selectable option; and
in response to receiving the selection of the first selectable option:
stopping the generation for display of the second piece of content; and
generating for display the second segment of the third piece of content based, at least in part, on the first entry of the plurality of entries.

10. The method of claim 1, further comprising:
generating for display a second segment of the second piece of content;
detecting a first user input during the generating for display the second segment of the second piece of content; and
in response to detecting the first user input:
determining, that the first user input corresponds to the first 3D model within the second piece of content;
accessing the index associated with the second piece of content;
identifying the first entry of the plurality entries, wherein the first entry of the plurality of entries associates the first 3D model with the first segment of the at least one segment;
stopping the generation for display of the second segment of the second piece of content; and
generating for display the first segment of the first piece of content based, at least in part, on the first entry of the plurality of entries.

11. An apparatus comprising:
control circuitry; and
at least one memory including computer program code for one or more programs, the at least one memory and the computer program code configured to, with the control circuitry, cause the apparatus to perform at least the following:
receive a first piece of content comprising at least one segment, wherein the first piece of content was recorded by a first camera;
identify a first object within a first segment of the at least one segment;
compare the first object with a plurality of three-dimensional (3D) models stored in a database;
in response to determining that at least one 3D model of the plurality of 3D models corresponds to the first object, identify a first 3D model of the plurality of 3D models based, at least in part, on comparing the first object with the plurality of 3D models stored in the database;
generate for display a second piece of content, by combining the first 3D model of the plurality of 3D models with the first piece of content; and
generate an index associated with the second piece of content, wherein,
the index associated with the second piece of content comprises a plurality of entries;
a first entry of the plurality of entries, associates the first 3D model with the first segment; and
the index is stored in at least one memory.

12. The apparatus of claim 11, wherein the apparatus is further caused to:
identify a second object within a second segment of the at least one segment;
compare the second object with the plurality of 3D models stored in the database; and
in response to determining that at least one 3D model of the plurality of 3D models corresponds to the second object, identify a second 3D model of the plurality of 3D models based, at least in part, on comparing the second object with the plurality of 3D models stored in the database.

13. The apparatus of claim 12, wherein:
the second piece of content is generated by combining the first 3D model of the plurality of 3D models and the second 3D model of the plurality of 3D models with the first piece of content; and
a second entry of the plurality of entries, associates the second 3D model with the second segment.

14. The apparatus of claim 13, wherein the apparatus is further caused, in response to determining that none of the plurality of 3D models corresponds to the first object, to:
transmit a notification to the first camera, wherein the notification requests additional information;
receive from the first camera, additional information; and
generate the first 3D model using the first piece of content and the additional information.

15. The apparatus of claim 14, wherein the additional information comprises additional pieces of content depicting the first object from a plurality of different angles.

16. The apparatus of claim 15, wherein the notification comprises a first instruction.

17. The apparatus of claim 16, wherein the apparatus is further caused to change the first camera from a first position to a second position according to the first instruction, wherein the additional information is captured using the first camera at the second position.

18. The apparatus of claim 11, wherein the apparatus is further caused to identify the first object within the first piece of content using an object recognition algorithm.

19. The apparatus of claim 11, wherein the apparatus is further caused to:
generate for display a first selectable option, wherein:
the first selectable option corresponds to a second segment of a third piece of content; and
the first entry also associates the first 3D model with the second segment of the third piece of content;
receive a selection of the first selectable option; and
in response to receiving the selection of the first selectable option:
stop the generation for display of the second piece of content; and
generate for display the second segment of the third piece of content based, at least in part, on the first entry of the plurality of entries.

20. (canceled)

21. A non-transitory computer-readable medium having instructions encoded thereon that, when executed by control circuitry, cause the control circuitry to:
receive a first piece of content comprising at least one segment, wherein the first piece of content was recorded by a first camera;
identify a first object within a first segment of the at least one segment;
compare the first object with a plurality of three-dimensional (3D) models stored in a database;
in response to determining that at least one 3D model of the plurality of 3D models corresponds to the first object, identify a first 3D model of the plurality of 3D models based, at least in part, on comparing the first object with the plurality of 3D models stored in the database;
generate for display a second piece of content, by combining the first 3D model of the plurality of 3D models with the first piece of content; and
generate an index associated with the second piece of content, wherein,
the index associated with the second piece of content comprises a plurality of entries;
a first entry of the plurality of entries, associates the first 3D model with the first segment; and
the index is stored in at least one memory.

22.-40. (canceled)
